(19) United States
(12) Patent Application Publication
(10) Pub. No.: US 2025/0135343 A1
(43) Pub. Date: May 1, 2025

(54) METHOD AND APPARATUS FOR OBTAINING CLUE IN VIRTUAL SCENE, STORAGE MEDIUM, AND PROGRAM PRODUCT

(71) Applicant: SHANGHAI LILITH TECHNOLOGY CORPORATION, Shanghai (CN)

(72) Inventor: Jia WEI, Shanghai (CN)

(21) Appl. No.: 18/724,113

(22) PCT Filed: Jul. 5, 2023
(86) PCT No.: PCT/CN2023/105831

§ 371 Date: Jun. 25, 2024

(51) Int. Cl. A63F 13/537

(52) U.S. Cl. CPC A63F 13/537

(57) ABSTRACT

The present disclosure relates to a method and apparatus for obtaining a clue in a virtual scene, a storage medium, and a program product. The method includes displaying a first virtual scene including multiple virtual characters and multiple virtual objects, where the multiple virtual characters include a first virtual character corresponding to a first user and a second virtual character corresponding to a second user, and controlling the first virtual character to interact with a first virtual object in response to a control instruction from the first user for the first virtual character to obtain a first search clue to be added to a clue pool.

### CROSS-REFERENCE TO RELATED APPLICATIONS

This application is a national stage application of PCT international application No. PCT/CN2023/105831 filed on Jul. 5, 2023, entitled “METHOD AND APPARATUS FOR OBTAINING CLUE IN VIRTUAL SCENE, STORAGE MEDIUM, AND PROGRAM PRODUCT”, the entire contents of which are incorporated herein by reference.

### TECHNICAL FIELD

The present disclosure relates to the field of internet technology, particularly to a method and apparatus for obtaining a clue in a virtual scene, a storage medium, and a program product.

### BACKGROUND

Currently, computer games are becoming increasingly common in people's daily lives, among which puzzle-solving games are typical computer games.

In puzzle-solving games, users typically investigate virtual objects in virtual scenes and solve puzzles using the clues obtained from the investigations.

### SUMMARY

In a first aspect, a method for obtaining a clue in a virtual scene is provided. The method includes: displaying a first virtual scene including multiple virtual characters and multiple virtual objects, the multiple virtual characters including a first virtual character corresponding to a first user and a second virtual character corresponding to a second user; and controlling the first virtual character to interact with a first virtual object in response to a control instruction from the first user for the first virtual character to obtain a first search clue to be added to a clue pool.

In an embodiment, controlling the first virtual character to interact with the first virtual object includes controlling the first virtual character to approach a predetermined range around the first virtual object, and displaying an interaction control when the first virtual character enters the predetermined range around the first virtual object, and controlling, in response to a first trigger instruction from the first user for the interaction control, the first virtual character to interact with the first virtual object in an interaction manner corresponding to the first virtual object.

In an embodiment, controlling the first virtual character to interact with the first virtual object to obtain the first search clue to be added to the clue pool includes displaying a password input interface during interaction of the first virtual character with the first virtual object, and receiving a password input through the password input interface; and obtaining the first search clue if the password is successfully verified.

In an embodiment, the clue pool includes a shared clue pool, and the method further includes adding the first search clue to the shared clue pool in response to a sharing instruction triggered by the first user. The shared clue pool also includes a second search clue obtained through interaction between the second character and a second virtual object.

In an embodiment, adding the first search clue to the shared clue pool in response to the sharing instruction triggered by the first user includes: displaying a sharing control around the first virtual object; and adding the first search clue to the shared clue pool in response to a second trigger instruction from the first user for the sharing control.

In an embodiment, the method further includes: if the shared clue pool lacks a target search clue associated with the target virtual object, displaying the target search clue in the shared clue pool.

In an embodiment, the clue pool includes a private clue pool. The method further includes adding the first search clue to the private clue pool in response to a privatization instruction from the first user for the first virtual object.

In an embodiment, adding the first search clue to the private clue pool in response to a privatization instruction from the first user for the first virtual object includes displaying a privatization control around the first virtual object, and adding the first search clue to the private clue pool in response to a third trigger instruction from the first user for the private collection control.

In an embodiment, the method further includes displaying a navigation interface for the first virtual scene. The navigation interface includes location information of a virtual space in the first virtual scene that is accessible to the virtual characters.

In an embodiment, the method further includes displaying a second virtual scene including multiple virtual characters, and displaying, in the second virtual scene, the search clue obtained from the first virtual scene.

In an embodiment, the second virtual scene includes a virtual desktop. The multiple virtual characters are located around the virtual desktop, and a display area for the search clue is located above the virtual desktop.

In an embodiment, displaying the search clue obtained from the first virtual scene includes displaying the search clue according to a field of view of the first virtual character, or displaying the search clue according to a field of view corresponding to a target location, the target location being located outside of the multiple virtual characters.

In an embodiment, the method further includes, in a case of displaying the search clue according to the field of view of the first virtual character, in response to a field of view change instruction from the first user for the first virtual character, displaying the search clue according to a changed field of view.

In an embodiment, displaying the search clue obtained from the first virtual scene includes displaying the clue pool on a current interface in response to a clue pool invocation operation by the first user, and displaying, in response to a triggered instruction of the first user for the search clue in the clue pool, a triggered search clue.

In an embodiment, the method further includes displaying the virtual object associated with the search clue in the second virtual scene.

In an embodiment, displaying the search clue obtained from the first virtual scene includes displaying a content play control in the second virtual scene if the search clue is of a multimedia type, and playing the search clue in response to a fourth trigger instruction from the first user for the content play control.

In an embodiment, the method further includes collecting a first voice signal from the first user and sending speech information to a server. The speech information carries the first voice signal and instructs the server to send the first voice signal to terminals corresponding to the virtual characters for play.

In an embodiment, collecting the first voice signal from the first user includes, when a current moment is determined to be a speaking moment of the first virtual character according to a predetermined speaking order, displaying a speaking prompt for the first virtual character in the second virtual scene and collecting the first voice signal, where the speaking prompt is used to prompt the first user to speak.

In an embodiment, collecting the first voice signal from the first user includes displaying a speaking control in the second virtual scene, and collecting the first voice signal in response to a fifth trigger instruction from the first user for the speaking control.

In a second aspect, a computer device is provided, including a memory and a processor. The memory stores a computer program. The processor, when executing the computer program, performs steps of any one of the above methods according to the first aspect.

In a third aspect, a computer-readable storage medium storing a computer program is provided. The computer program, when executed by a processor, implements steps of any one of the above methods according to the first aspect.

In a fourth aspect, a computer program product including a computer program is provided. The computer program, when executed by a processor, implements steps of any one of the above methods according to the first aspect.

### BRIEF DESCRIPTION OF THE DRAWINGS

FIG. 1 shows an application environment of a method for obtaining a clue in a virtual scene according to an embodiment.

FIG. 2 is a schematic flow chart of a method for obtaining a clue in a virtual scene according to an embodiment.

FIG. 3 is a schematic diagram of a shared clue pool according to an embodiment.

FIG. 4 is a schematic diagram of a private clue pool according to an embodiment.

FIG. 5 is a schematic diagram of a privatization control according to an embodiment.

FIG. 6 is a schematic flow chart of interaction between a first virtual character and a first virtual object according to an embodiment.

FIG. 7 is a schematic diagram of an interaction control according to an embodiment.

FIG. 8 is a schematic diagram of clue prompt information according to an embodiment.

FIG. 9 is a schematic flow chart of obtaining a first search clue according to an embodiment.

FIG. 10 is a schematic flow chart of displaying a search clue in a second virtual scene according to an embodiment.

FIG. 11 is a schematic diagram of a second virtual scene according to an embodiment.

FIG. 12 is a schematic diagram of a multimedia play interface according to an embodiment.

FIG. 13 is a schematic flow chart of another method for obtaining a clue in a virtual scene according to an embodiment.

FIG. 14 is a schematic flow chart of displaying a second virtual scene according to an embodiment.

FIG. 15 is a structural block diagram of an apparatus for obtaining a clue in a virtual scene according to an embodiment.

FIG. 16 is a structural block diagram of another apparatus for obtaining a clue in a virtual scene according to an embodiment.

FIG. 17 is a structural block diagram of another apparatus for obtaining a clue in a virtual scene according to an embodiment.

FIG. 18 is a structural block diagram of another apparatus for obtaining a clue in a virtual scene according to an embodiment.

FIG. 19 shows an internal structure of a computer device according to an embodiment.

FIG. 20 shows an internal structure of a computer device according to an embodiment.

### DETAILED DESCRIPTION

To clarify the purpose, technical solution, and advantages of the present disclosure, detailed explanations are provided below in conjunction with the accompanying drawings and embodiments. It should be understood that the specific embodiments described here are only intended to explain the present disclosure and are not intended to limit the scope of the present disclosure.

Currently, puzzle-solving games, or games involving puzzle solving, have become increasingly common in people's daily lives. Among them, the puzzle-solving games mentioned in the embodiments of the present disclosure may include online murder mystery games. The puzzle-solving games commonly seen today are typically standalone games, meaning that they are played by individual users. Specifically, users can interact with virtual objects in the puzzle-solving scenes using input components such as a mouse, to investigate the virtual objects and therefore obtain clues that can be used to solve the puzzle.

However, existing puzzle-solving games often employ a simplistic approach to investigating virtual objects, which lacks support for sharing clues and puzzle-solving interactions among multiple players, resulting in limited flexibility in investigating clues. In light of this, the embodiments of the present disclosure provide a method and apparatus for obtaining a clue in a virtual scene, a storage medium, and a program product, which expand the ways in which virtual objects can be investigated and improve the flexibility of investigation.

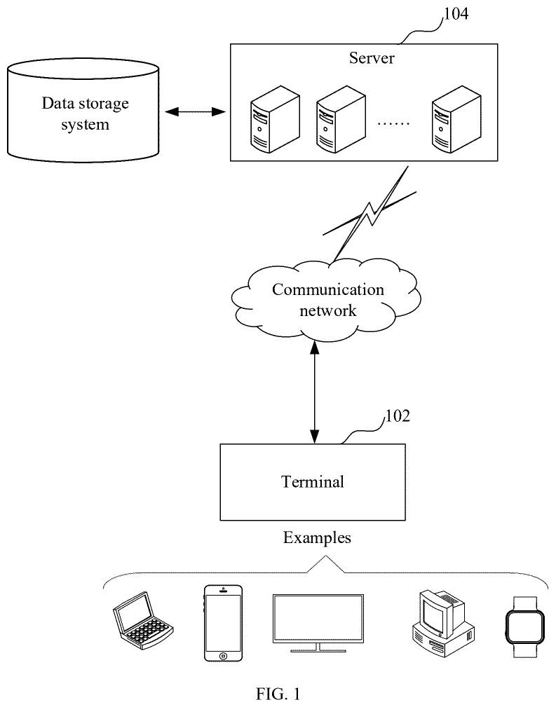

The methods for obtaining a clue in a virtue scene according to embodiments of the present disclosure can be applied in the application environment shown in FIG. 1. In this environment, a terminal 102 communicates with a server 104 via a network. The terminal 102 can be various devices such as a personal computer, a laptop, a smartphone, a tablet, etc. The server 104 can be implemented as an independent server or a server cluster including multiple servers.

In an embodiment, as shown in FIG. 2, a method for obtaining a clue in a virtue scene is provided. Taking the application in a first terminal corresponding to a first user as an example, as shown in FIG. 2, the method includes the following steps 201-202.

In step 201, a first terminal displays a first virtual scene.

The first virtual scene includes multiple virtual characters and objects. The multiple virtual characters may have different appearances. It should be noted that the multiple virtual characters are not limited to human appearances, but may also include animal appearances, etc. The appearances of the characters are not limited in the embodiments of the present disclosure. The virtual characters can correspond to different users (i.e., players) and be controlled by the corresponding users. For ease of the following description, the multiple virtual characters can be divided into a first virtual character corresponding to a first user and a second virtual character corresponding to a second user. Readers should understand that the first user and the second user here are only intended to represent different users and do not imply the existence of only two users or two types of users. Similarly, the first virtual character and the second virtual character are only intended to represent different virtual characters and do not imply the existence of only two virtual characters or two types of virtual characters.

The multiple virtual objects may include, for example, virtual tapes, virtual notebooks, virtual phones, etc. The multiple virtual objects can be scattered in different locations within the first virtual scene, and may intersect or contain each other. For instance, in a possible scene, the virtual objects may include a virtual notebook and a virtual drawer, where the virtual notebook can be contained within the virtual drawer. The virtual objects can either be hidden within the first virtual scene or be visually presented within the first virtual scene.

Virtual characters can interact with virtual objects under the control of corresponding users. For example, virtual characters can open the virtual object, move the virtual object, flip and fold the virtual object, destroy the virtual object, alter the external form of the virtual object, change the external color of the virtual object, etc. The embodiments of the present disclosure do not specifically limit the way in which virtual characters interact with virtual objects.

In addition, the virtual characters can also interact with each other under the control of corresponding users. For instance, the virtual characters can chat with each other, engage in physical interactions, etc. The embodiments of the present disclosure do not specifically limit the ways in which virtual characters interact with each other.

In addition to the virtual characters and virtual objects, the first virtual scene may optionally include Non-Player Characters (NPC), with whom the virtual characters can interact under the control of the corresponding users. For example, virtual characters can chat with NPCs.

In optional embodiments of the present disclosure, the first terminal can receive a scene trigger instruction from the first user and display the first virtual scene in response to the scene trigger instruction. The scene trigger instruction can be, for example, a virtual button trigger instruction, a gesture instruction, etc. No specific limitations is made to the type of the scene trigger instruction in the present disclosure. In optional embodiments of the present disclosure, upon receiving the scene trigger instruction from the first user, the first terminal can send a scene obtaining request to the server. The scene obtaining request instructs the server to generate the first virtual scene and return the same to the first terminal for display. The virtual scenes described in the present disclosure can replicate various real-world environments, such as entire or partial areas of buildings such as hospitals, office buildings, factories, standalone houses, as well as outdoor environments like parks and playgrounds.

Optionally, the puzzle-solving game described in the embodiments of the present disclosure may include multiple clue-searching stages, each corresponding to a different virtual scene. For instance, in different clue-searching stages, virtual characters may have access to different virtual spaces within the virtual scenes, or they may interact with different virtual objects.

For example, the puzzle-solving game according to the embodiments of the present disclosure includes a first clue-searching stage and a second clue-searching stage. In the first clue-searching stage, the virtual scene may include a virtual study and a virtual living room which are inaccessible to virtual characters, while a virtual bedroom in the virtual scene is accessible to the virtual characters. Additionally, in the first clue-searching stage, a virtual notebook and a virtual alarm clock in the virtual bedroom are interactable. In the second clue-searching stage, however, a virtual study, a virtual living room, and a virtual bedroom in the corresponding virtual scene are all accessible to virtual characters. In addition, in the second clue-searching stage, besides the virtual notebook and the virtual alarm clock in the virtual bedroom, a virtual computer in the virtual bedroom is also interactable. In the case where there are multiple clue-searching stages corresponding to different virtual scenes, upon receiving a scene trigger instruction from the first user, the first terminal displays the first virtual scene corresponding to the current clue-searching stage in response to the scene trigger instruction.

In addition, during the current clue-searching stage, the first terminal can also display a navigation interface for the first virtual scene. The navigation interface includes location information of virtual spaces in the first virtual scene that are accessible to virtual characters. Optionally, the navigation interface can also include positional information of the first virtual character and/or the second virtual character in the first virtual scene.

In optional embodiments of the present disclosure, the display interface of the first virtual scene can contain a navigation interface invocation control. Upon detecting a triggering operation on the navigation interface invocation control, the first terminal can display the navigation interface for the first virtual scene. Optionally, the first terminal can overlay the navigation interface onto the display interface of the first virtual scene. For example, the first terminal can overlay the navigation interface in the top left corner of the display interface of the first virtual scene. Alternatively, the first terminal can have the navigation interface overlay the entire display interface of the first virtual scene.

In optional embodiments of the present disclosure, the display interface of the first virtual scene may also include a character relationship invocation control. Upon detecting a triggering operation on the character relationship control, the first terminal can display character relationship information reflecting the relationships between the virtual characters and/or between the virtual characters and the NPC characters. The character relationship information can be presented in, for example, a character relationship table or diagram.

In optional embodiments of the present disclosure, the display interface of the first virtual scene may also include a recall invocation control. Upon detecting a triggering operation on the recall invocation control, the first terminal can display recall information. The recall information can be in the form of text, video, audio, image, etc., containing personal stories associated with the first virtual character.

In step 202, in response to a control instruction from the first user for the first virtual character, the first terminal controls the first virtual character to interact with a first virtual object to obtain a first search clue to be added to a clue pool.

As described above, the virtual characters can interact with the virtual objects under the control of corresponding users. Through the interaction between virtual characters and virtual objects, search clues corresponding to the virtual objects can be obtained. Specifically, taking the first virtual character as an example, during the interaction between the first virtual character and the first virtual object, the first terminal can send interaction information to the server. The server can then obtain the first search clue corresponding to the first virtual object based on the interaction information and send the same to the first terminal. For example, the server can add the first search clue to a clue pool and send the clue pool to the first terminal. The first terminal can thus display the first search clue using the clue pool as a carrier. In the embodiments of the present disclosure, search clues can be in the form of text, image, audio, video, etc., without specific limitations in the embodiments of the present discourse.

It should be noted that the control instruction from the user for the virtual character can be input through devices such as a mouse, a gamepad, keyboard keys, or a touch screen, without specific limitations in the embodiments of the present disclosure.

As described above, search clues obtained through interactions between virtual characters and virtual objects can be added to the clue pool. The clue pool can be used to contain the search clues. In optional embodiments of the present disclosure, the clue pool may include a shared clue pool and a private clue pool.

The shared clue pool contains clues obtained through interactions between different virtual characters (e.g., a first virtual character and a second virtual character) and virtual objects. Clues contained in the shared clue pool can be viewed by each user (e.g., a first user and a second user). In other words, the shared clue pool not only contains the first search clue obtained through the interaction between the first virtual character and the first virtual object, but also includes a second search clue obtained through the interaction between the second virtual character and a second virtual object. It can be understood that the present disclosure is not limited to two virtual characters and may include more virtual characters controlled by different users, such as a third virtual character, a fourth virtual character, and a fifth virtual character. According to share instructions, search clues obtained through the interactions between different virtual characters and different virtual objects under the control of different users can all be shared to the shared clue pool for all users to view.

In optional embodiments of the present disclosure, different users each have their own private clue pool. The private clue pool is used to contain the search clues obtained through the interaction between the virtual character and the virtual objects under the control of the corresponding user, and the clues contained in the private clue pool can only be viewed by the corresponding user. Taking the first user as an example, the corresponding private clue pool contains search clues obtained through the interaction between the first virtual character and the virtual objects, and the contained search clues can only be viewed by the first user.

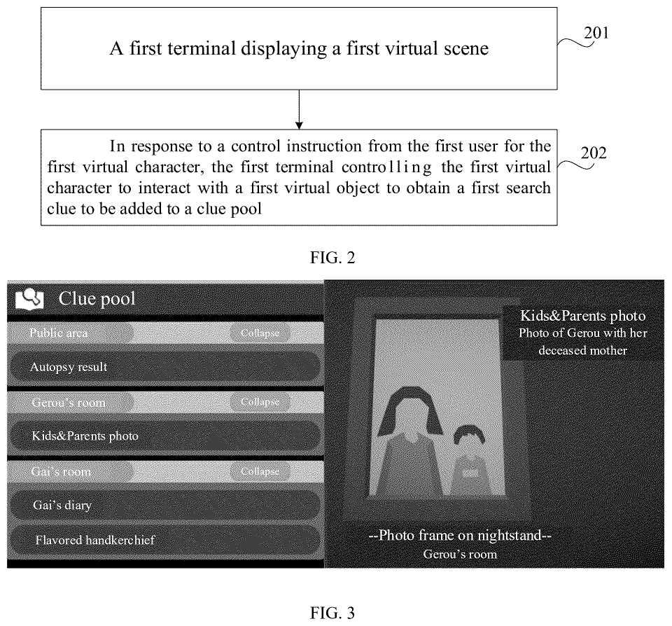

FIG. 3 illustrates an exemplary shared clue pool. As shown in FIG. 3, the shared clue pool includes a clue table that contains descriptive information corresponding to the search clues, and the descriptive information is categorized according to virtual spaces included in the virtual scene. After the descriptive information corresponding to one search clue is triggered, that search clue can be displayed on the right side of the clue pool. In addition, each virtual space also has a collapse control. Upon detecting a triggering operation on the collapse control corresponding to a specific virtual space, the descriptive information of the search clue corresponding to that virtual space can be hidden in the clue table.

In optional embodiments of the present disclosure, the display interface of the first virtual scene can include a shared clue pool invocation control. Upon detecting a triggering operation on the shared clue pool invocation control, the first terminal can display the shared clue pool. Optionally, the first terminal can overlay the shared clue pool interface onto the display interface of the first virtual scene. For example, the first terminal can overlay the shared clue pool on the right half of the display interface of the first virtual scene. Alternatively, the first terminal can have the shared clue pool overlay the entire display interface of the first virtual scene.

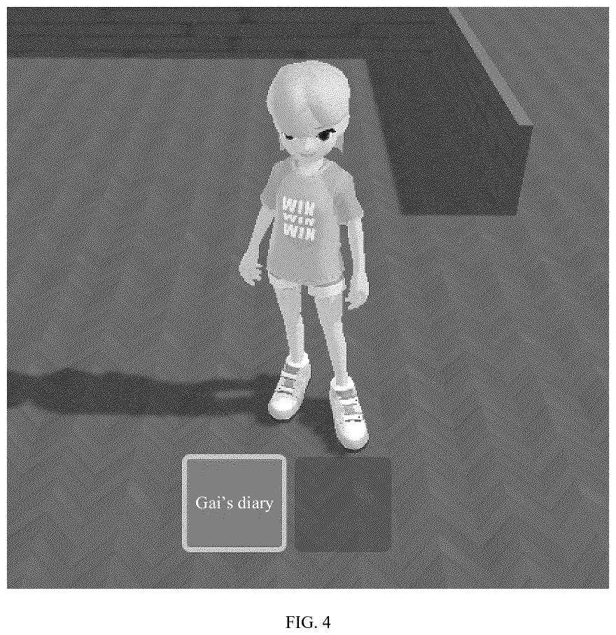

Referring to FIG. 4, which illustrates an exemplary private clue pool, the private clue pool can be overlaid and displayed within the display interface of the first virtual scene. In FIG. 4, the private clue pool includes a diary owned by Gai. As described previously, descriptive information of the search clues is displayed in the private clue pool. Upon the descriptive information of the search clue being triggered, that search clue can be overlaid and displayed within the display interface of the first virtual scene. Additionally, the display interface of the first virtual scene can also include a private clue pool invocation control. Upon detecting a triggering operation on the private clue pool invocation control, the first terminal can display the private clue pool.

The method for obtaining a clue in a virtual scene provided in the present embodiment involves displaying a first virtual scene including multiple virtual characters and multiple virtual objects. The multiple virtual characters in the first virtual scene include a first virtual character corresponding to the first user and a second virtual character corresponding to the second user. In response to a control instruction from the first user for the first virtual character, the first virtual character is controlled to interact with the first virtual object to obtain the first search clue to be added to the clue pool. In the technical solution provided by the present disclosure, the first virtual scene allows multiple different users to control their corresponding virtual characters to interact with virtual objects in the first virtual scene to obtain clues. Meanwhile, the obtained clues can be added to the clue pool, thus expanding the ways of investigating virtual objects and enhancing the flexibility of the investigation.

As described above, in optional embodiments of the present disclosure, the clue pools can include a private clue pool and a shared clue pool. In the following description, the ways that the first terminal triggers the addition of the first search clue to the private clue pool and the shared clue pool as described above will be explained respectively.

I. The first terminal triggers the addition of the first search clue to the private clue pool of the first user.

In optional embodiments of the present disclosure, the first terminal can receive a privatization instruction from the first user for the first virtual object. Optionally, a privatization control can be displayed around the first virtual object. Upon detecting a third trigger instruction from the first user on the privatization control, the first terminal can receive the privatization instruction, and trigger the addition of the first search clue to the private clue pool of the first user in response to the privatization instruction. Specifically, upon receiving the privatization instruction, the first terminal sends a second add instruction to the server. Upon receiving the second add instruction, the server adds the first search clue to the private clue pool of the first user.

In optional embodiments of the present disclosure, after the first search clue is added to the private clue pool, the first virtual object associated with the first search clue becomes unavailable for interaction with virtual characters other than the first virtual character, which ensures the exclusivity of the first user's access to the first search clue. Similarly, a second virtual character, a third virtual character, etc. controlled by other users can also have their own exclusive private clue pools. It should be understood that the first search clue can also not be exclusive to the first user, and in this case, even after the first search clue is added to the private clue pool of the first user, the first virtual object remains accessible for interaction with virtual characters other than the first virtual character. For example, in a puzzle-solving game, users can be grouped, and all users in the same group can perform privatization operations on the same search clue.

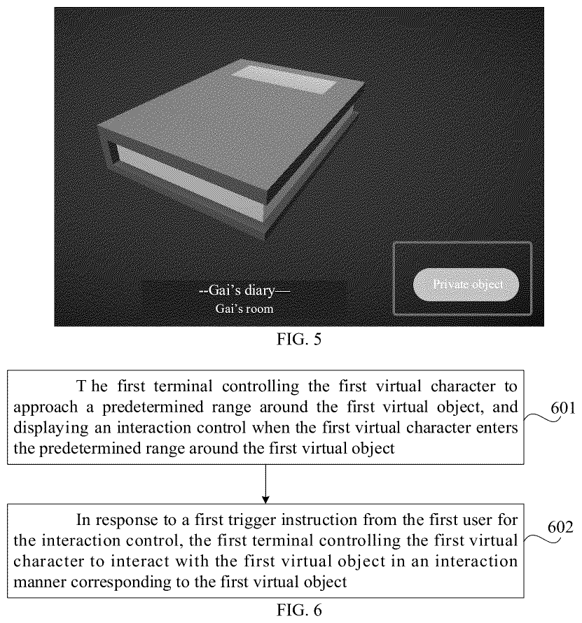

FIG. 5 is a schematic diagram of an exemplary privatization control. As shown in FIG. 5, a privatization control can be displayed around Gai's diary (i.e., the first virtual object). Upon detecting the third trigger instruction on this privatization control, the first terminal can receive a privatization instruction and add Gai's diary to the private clue pool of the first user.

II. The first terminal triggers the addition of the first search clue to the shared clue pool.

In optional embodiments of the present disclosure, the first terminal can receive a sharing instruction from the first user for the first virtual object. Optionally, a sharing control can be displayed around the first virtual object. Upon detecting a second trigger instruction from the first user for this sharing control, the first terminal can receive a sharing instruction, and trigger the addition of the first search clue to the shared clue pool in response to the sharing instruction. Specifically, upon receiving the sharing instruction, the first terminal can send a first addition instruction to the server. Upon receiving the first addition instruction, the server can add the first search clue to the shared clue pool.

In another optional embodiment of the present disclosure, only a privatization control can be set around the first virtual object, without providing a sharing control. In this case, during the interaction between the first virtual character and the first virtual object, if no third trigger instruction for the privatization control is received, it is allowed to trigger the addition of the first search clue to the shared clue pool. Conversely, if the third trigger instruction for the privatization control is received, it can trigger the addition of the first search clue to the private clue pool of the first user.

In yet another optional embodiment of the present disclosure, only a sharing control can be set around the first virtual object, without providing a privatization control. In this case, during the interaction between the first virtual character and the first virtual object, if no second trigger instruction for the sharing control is received, it is allowed to trigger the addition of the first search clue to the private clue pool of the first user. Conversely, if the second trigger instruction for the sharing control is received, it can trigger the addition of the first search clue to the shared clue pool.

In addition, optionally, whether the first search clue corresponding to the first virtual object can be privatized can be preset by technical personnel. For example, search clues that may significantly affect the reasoning process of puzzle-solving games are generally not allowed to be privatized. If the first search clue is configured as non-private, it cannot be added to the private clue pool. In this case, no privatization control is set around the first virtual object, meaning that the first search clue will be added to the shared clue pool, regardless of whether a sharing control is set or triggered.

It should be noted that the sharing control is similar to the privatization control shown in FIG. 5. For brevity, no schematic diagram of the sharing control is provided here.

In optional implementations of the present disclosure, after a specific clue-searching stage, if the shared clue pool lacks a target search clue associated with a target virtual object, the first terminal displays the target search clue in the shared clue pool. The target virtual object refers to a virtual object in a puzzle-solving game that has an importance level being preset as important, and the target search clue refers to a search clue associated with the corresponding target virtual object. In practical applications, some search clues have a significant impact on the reasoning process of puzzle-solving games. If this type of search clue is not discovered during the clue-searching stage, it may lead to users being unable to ultimately solve the puzzle of the game. Considering this, after the current clue-searching stage ends, the server can determine whether a search clue associated with a virtual object whose importance level is preset as important is already in the shared clue pool. If the shared clue pool lacks the search clue, the server can add the target search clue to the shared clue pool, so that even if the shared clue pool lacks the search clue associated with the virtual object preset as important, the first terminal can still display this search clue in the shared clue pool for the first user to view. However, the present disclosure is not limited to this implementation. Another possible implementation can be that when the server determines that a target search clue is not in the shared clue pool, the server can issue a prompt instruction to the first terminal, prompting the first user about the lack of the key search clue and providing a remedy opportunity. For example, the target search clue is displayed in the shared clue pool in a different way (highlighted or blurred) than other already added search clues. By clicking on this target search clue, the corresponding clue-searching stage can be restarted for clue searching. It should be understood that the server can also issue a prompt instruction to all terminals in the game session, or issue a prompt instruction to the terminal that controls the virtual character most relevant to the target search clue.

Referring to FIG. 6, on the basis of the embodiment illustrated in FIG. 2, optionally, the technical process of controlling the first virtual character to interact with the first virtual object in step 202 can include the following steps 601-602.

In step 601, the first terminal controls the first virtual character to approach a predetermined range around the first virtual object, and displays an interaction control when the first virtual character enters the predetermined range around the first virtual object.

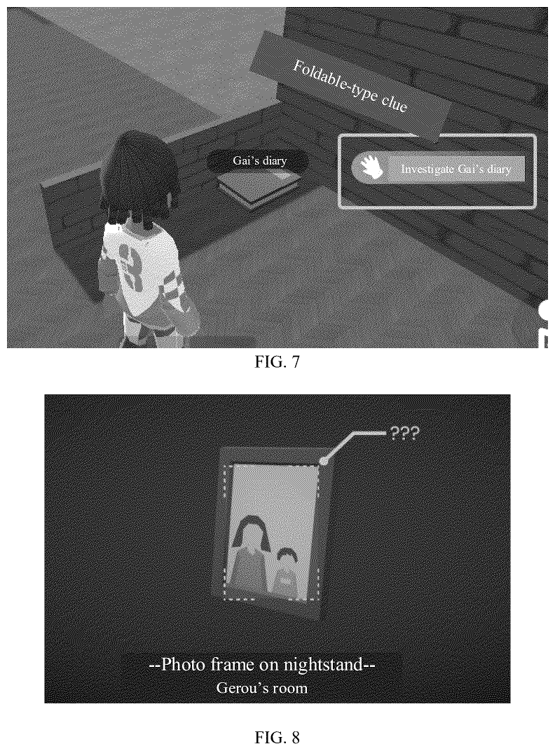

Generally, if the search clues corresponding to the virtual objects are easy for the users to find, it may detract from the fun of puzzle-solving games and affect the flexibility of puzzle-solving games. To address this issue, in the embodiments of the present disclosure, the search clues corresponding to the virtual objects can be obtained only when the virtual characters are close to the virtual objects. Specifically, taking the first user as an example, only when the first virtual character enters the predetermined range around the first virtual object under the control of the first user, the first terminal displays the interaction control, allowing the first virtual character to interact with the first virtual object upon the triggering of the interaction control by the first user. FIG. 7 is a schematic diagram of an exemplary interaction control, i.e., the control ‘Investigate Gai's Diary’.

In optional embodiments of the present disclosure, when the virtual character enters the predetermined range around the virtual object, i.e., when the virtual character is close to the virtual object, clue prompt information can be displayed around the virtual object to inform the user that the virtual object is associated with search clues and further investigation is needed. The clue prompt information can be in the form of image, text, etc. FIG. 8 is a schematic diagram of an exemplary clue prompt information. In FIG. 8, “???” is just the clue prompt information.

In step 602, in response to a first trigger instruction from the first user for the interaction control, the first terminal controls the first virtual character to interact with the first virtual object in an interaction manner corresponding to the first virtual object.

When the interaction control is displayed, the first user can trigger the interaction control, such that the first terminal receives the first trigger instruction for the interaction control. Upon receiving the first trigger instruction, the first terminal can then control the first virtual character to interact with the first virtual object in the interaction manner corresponding to the first virtual object. For example, the interaction manner may include opening the virtual object, moving the virtual object, flipping and folding the virtual object, destroying the virtual object, altering the external form of the virtual object, changing the external color of the virtual object, etc. The interaction manners are not limited in the embodiments of the present disclosure.

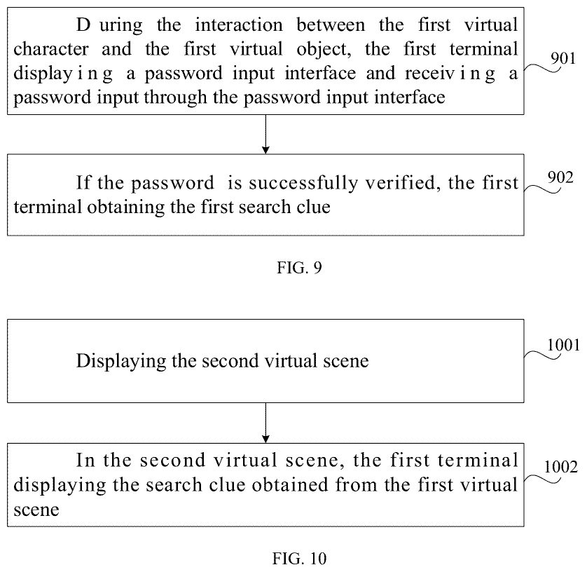

Referring to FIG. 9, on the basis of the embodiments shown in FIG. 2 or in FIGS. 2 and 6, optionally, the technical process for obtaining the first search clue in step 202 includes the following steps 901-902.

In step 901, during the interaction between the first virtual character and the first virtual object, the first terminal displays a password input interface and receives a password input through the password input interface.

In an optional implementation of the present disclosure, upon receiving the first trigger instruction for the interaction control, the first terminal can display the password input interface.

In another optional implementation of the present disclosure, the first terminal can display the password input interface when the interaction between the first virtual character and the first virtual object meets a predetermined requirement.

In yet another optional implementation of the present disclosure, the first terminal can display the password input interface when the first virtual character enters the predetermined range around the first virtual object.

It should be noted that the password input interface can be displayed and overlaid on the display interface of the first virtual scene or can fully cover the display interface of the first virtual scene.

It should also be noted that the password input through the password input interface can be in the form of number, text, picture, audio, etc., without specific limitations in the present disclosure.

In step 902, if the password is successfully verified, the first terminal obtains the first search clue.

In optional embodiments of the present disclosure, the first terminal can send the password input through the password input interface as interactive information to the server. The server can verify the password, and if the verification is successful, the server can add the first clue to the clue pool (i.e., the shared clue pool or the private clue pool) and provide the clue pool to the first terminal for displaying. Thus, the first terminal obtains the first search clue.

Referring to FIG. 10, on the basis of the embodiments described above, the present disclosure also provides a method for displaying a search clue in a second virtual scene different from the first virtual scene. As shown in FIG. 10, the technical process for displaying a search clue in the second virtual scene includes the following steps 1001-1002.

In step 1001, the second virtual scene is displayed.

After the clue-searching stage in the first virtual scene ends, the first terminal can receive a scene switching instruction from the first user to display the next virtual scene, i.e., the second virtual scene, and the next clue-searching stage begins. For example, the scene switching instruction can be a trigger instruction for a virtual button, a gesture instruction, etc. The specific type of the scene switching instruction is not limited in the present disclosure. Additionally, the switching of virtual scenes can also be triggered by instructions from other users in the game session, or triggered if all users in the game session agree. It can also be automatically triggered by the system when the server determines that all search clues in the first virtual scene have been obtained. In other words, after the clue-searching stage in the first virtual scene ends, the next virtual scene, i.e., the second virtual scene, can be automatically displayed and the next clue-searching stage begins.

It should be noted that in some puzzle-solving games (e.g., online murder mystery games), the stage of displaying the second virtual scene can also be referred to as the roundtable discussion stage. As the name suggests, this stage allows players (users corresponding to virtual characters) to discuss the search clue obtained from the first virtual scene (i.e., the search clues in the clue pools) around a virtual table, and ultimately arrive at the solution to the puzzle.

In optional embodiments of the present disclosure, the second virtual scene includes multiple virtual characters, which may correspond one-to-one with the multiple virtual characters in the first virtual scene. Additionally, the virtual characters in the second virtual scene can be controlled by the corresponding users too. For example, in the second virtual scene, the virtual characters can be controlled by users to move, rotate their heads, move their limbs, make expressions, interact with other virtual characters, etc., which are not limited in the embodiments of the present disclosure.

Additionally, the second virtual scene may optionally include a virtual table. The multiple virtual characters in the second virtual scene can be located around the virtual table. For instance, the virtual table can be circular or square.

Additionally, the second virtual scene may optionally include a search clue display area. The search clue display area is used to display search clues obtained from the first virtual scene (i.e., clues from the clue pools) during the clue-searching stage. Optionally, the search clue display area is located above the virtual table.

In step 1002, in the second virtual scene, the first terminal displays the search clue obtained from the first virtual scene.

Optionally, in the case that the second virtual scene includes a display area for search clues, the first terminal can display, in the display area, the search clue obtained from the first virtual scene (i.e., clues from the clue pools) during the clue-searching stage. It should be noted that in addition to displaying search clues in the second virtual scene, the first terminal can also display virtual objects associated with the search clues. Optionally, the first terminal can display virtual objects associated with the search clues in the display area for search clues. Furthermore, in optional embodiments of the present disclosure, the first terminal can display the search clues with a projection effect.

In optional embodiments of the present disclosure, while displaying the second virtual scene, the first terminal can receive a clue pool invocation operation by the first user. For example, the display interface of the second virtual scene may include a clue pool invocation control. Upon detecting a triggering operation on the clue pool invocation control, the first terminal receives the clue pool invocation operation. In response to the clue pool invocation operation, the first terminal can display the clue pool on the current interface. The clue pool can be a shared clue pool or a private clue pool of the first user. In response to a trigger instruction from the first user for the search clue in the clue pool, the first terminal can display the triggered search clue in the second virtual scene.

It should be noted that, as mentioned above, the search clues can be in the form of text, image, audio, video, etc., which are not limited in the embodiments of the present disclosure. The first terminal can directly display the search clues in the form of text, image, etc. However, for multimedia search clues, the first terminal can display a content play control in the second virtual scene. In response to a fourth trigger instruction on the content play control from the first user, the first terminal can play the multimedia search clue. Optionally, the first terminal can directly play the multimedia search clues in the second virtual scene, or overlay another interface on the display interface of the second virtual scene and play the multimedia search clues on that other interface, which are not limited in the embodiments of the present disclosure. Additionally, the first terminal can also display descriptive information of the multimedia search clues in the second virtual scene, allowing users to intuitively understand the content of the search clues based on the descriptive information.

In an optional implementation of the present disclosure, the first terminal can display the search clue according to the field of view of the first virtual character. It is to be noted that the executor here, i.e., the first terminal, is the terminal corresponding to the first user. Terminals corresponding to other users can display search clues according to the fields of view of the virtual characters corresponding to those other users. In other words, different terminals can display search clues according to the fields of view of the virtual characters controlled by the corresponding users.

Optionally, when displaying the search clue according to the field of view of the first virtual character, in response to a field of view change instruction from the first user for the first virtual character, the first terminal can display the search clues according to the changed field of view. The field of view change instruction can be received by the first terminal upon detecting the first user's rotation operation on the head of the first virtual character.

Optionally, when virtual objects associated with search clues are displayed in the second virtual scene, the first terminal can display the virtual objects according to the field of view of the first virtual character. Similar to the previous description, the executor here, i.e., the first terminal, is the terminal corresponding to the first user. Terminals corresponding to other users can display the virtual objects according to the fields of view of the virtual characters corresponding to those other users. In other words, different terminals can display the virtual objects according to the fields of view of the virtual characters controlled by the corresponding users.

Optionally, when displaying virtual objects according to the field of view of the first virtual character, in response to the instruction from the first user to change the field of view of the first virtual character, the first terminal can display the virtual object according to the changed field of view.

In another optional implementation of the present disclosure, the first terminal can display search clues according to the field of view corresponding to a target location. The target location is outside of the various virtual characters. Optionally, the target location can be a fixed location, for example, it can be above a virtual desktop. In this manner, different terminals can display search clues according to the same field of view (i.e., the field of view corresponding to the target location).

Optionally, when virtual objects associated with the search clues are displayed in the second virtual scene, the first terminal can display the virtual objects according to the field of view corresponding to the target location. In this manner, different terminals can display the virtual objects according to the same field of view (i.e., the field of view corresponding to the target location), where the target location is the location of the virtual character controlled by the player corresponding to the first terminal.

Besides displaying search clues, the second virtual scene can also allow users to speak and discuss the solving of puzzles.

When speaking, optionally, the first terminal can collect a first voice signal from the first user and send speech information to the server. The speech information carries the first voice signal and is used to instruct the server to send the first voice signal to the terminals corresponding to the respective virtual characters for play, allowing other users to listen to the first user's speech. Smartphones, tablets, and other terminal devices all have microphones, and their operating systems provide API interfaces for recording devices. Those skilled in the art are able to obtain the first user's first voice signal through the API interface and then combine it into speech information according to a communication protocol. In the present embodiment, the first voice signal refers to a digitized audio signal that supports computer storage and transmission. Additionally, the first terminal can also receive a second voice signal sent by the server. The second voice signal is the voice signal from a user other than the first user. Upon receiving the second voice signal, the first terminal can play it so that the first user can listen to the speech of the other user.

In an optional embodiment of the present disclosure, in the second virtual scene, the users can speak sequentially in order. In this case, if the first terminal determines, according to a predetermined speaking order, that the current moment is the speaking moment of the first virtual character, it can display a speech prompt for the first virtual character in the second virtual scene and collect the first voice signal. The speech prompt is used to prompt the first user to speak. In optional embodiments of the present disclosure, the speech prompt can be in the form of text or graphics, without specific limitations in the embodiments of the present disclosure.

In another optional embodiment of the present disclosure, the first terminal can display a speech control in the second virtual scene. In response to a fifth trigger instruction from the first user for the speech control, the first terminal can collect the first voice signal.

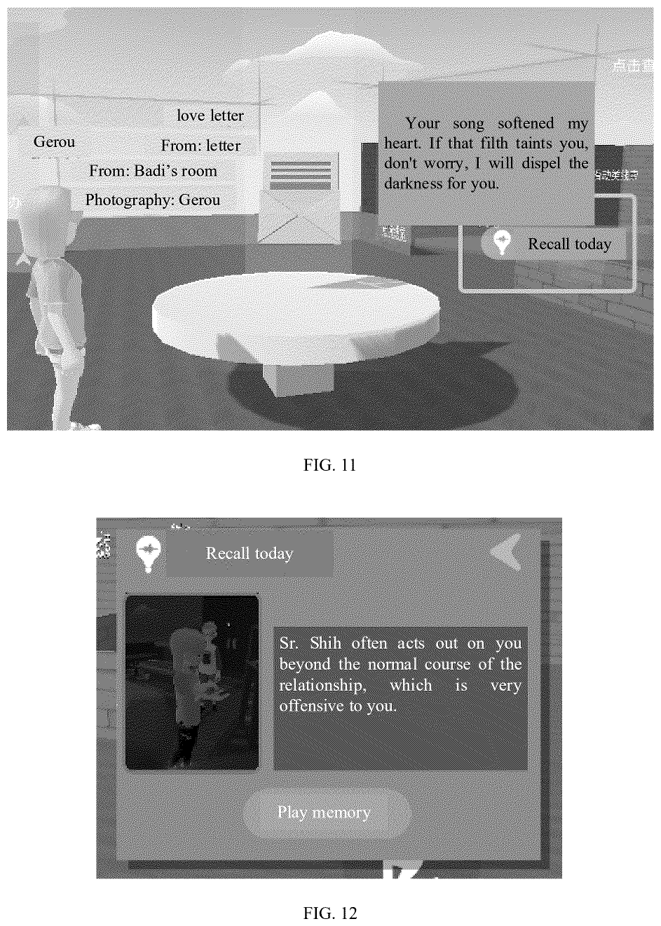

FIG. 11 illustrates an exemplary second virtual scene. It should be noted that although only one virtual character is depicted around a virtual desktop in FIG. 11, readers should understand that in practical applications, there can be multiple virtual characters around the virtual desktop in the second virtual scene. As shown in FIG. 11, the second virtual scene includes a ‘Recall today’ control, which is the content play control corresponding to the multimedia search clue. When the content play control is triggered, the first terminal can directly play the multimedia search clue in the second virtual scene or display an interface as shown in FIG. 12. The interface may include a ‘Play Memory’ control, which is another content play control. Upon detecting a triggering operation on the other content play control, the first terminal can play the multimedia search clue on the interface.

Referring to FIG. 11, if the search clue is of a multimedia type, the second virtual scene can also display descriptive information corresponding to that multimedia search clue. In FIG. 11, this descriptive information reads ‘Your song softened my heart. If that filth taints you, don't worry, I will dispel the darkness for you’.

Referring to FIG. 11, the second virtual scene can also display the name of the search clue, the source of the search clue, the location of the search clue, and the users to whom the search clue is presented.

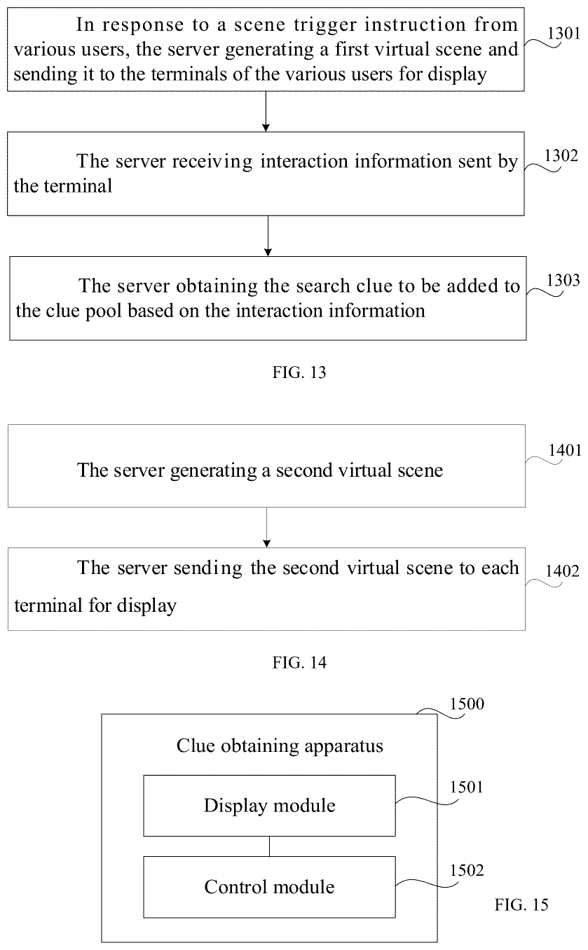

In an embodiment, as shown in FIG. 13, a method for obtaining a clue in a virtual scene is provided. Taking the application of the method to the server in FIG. 1 as an example, the method includes the following steps 1301-1303.

In step 1301, in response to a scene trigger instruction from various users, the server generates a first virtual scene and sends it to the terminals of the various users for display.

It should be noted that the various users mentioned in step 1301 can include the first user and the second user mentioned above. However, the first user and the second user here are merely intended to represent different users and do not imply the existence of only two users or two types of users.

In optional embodiments of the present disclosure, upon receiving the scene trigger instruction from the users, the terminal can send a scene obtaining request to the server. Upon receiving the scene obtaining request, the server can generate the first virtual scene and send it to the terminal.

The first virtual scene includes multiple virtual objects and virtual characters corresponding to the respective users. Since the first virtual scene has been detailed above, it will not be repeated in the embodiments of the present disclosure.

As described above, the puzzle-solving game in the embodiments of the present disclosure may include multiple clue-searching stages, where different clue-searching stages correspond to different virtual scenes. For example, different clue-searching stages may include different virtual spaces that are accessible to the virtual characters, or different virtual objects for virtual characters to interact with. In the embodiments of the present disclosure, the server can generate the first virtual scene based on the current clue-searching stage.

In optional embodiments of the present disclosure, the server can receive a stage configuration instruction before generating the first virtual scene. The stage configuration instruction can be, for example, a configuration instruction input by technical personnel. According to the stage configuration instruction, the server configures different virtual spaces that are accessible to virtual characters and/or different virtual objects for virtual characters to interact with.

In addition, after entering the current clue-searching stage, the server can generate a navigation interface for the first virtual scene. This navigation interface includes the location information of virtual spaces in the first virtual scene that are accessible to virtual characters. Optionally, the navigation interface may also include the position information of the first virtual character and/or the second virtual character in the first virtual scene. After generating the navigation interface, the server can send it to each terminal for display.

In addition, the server can also generate character relationship information, which may be presented through a character relationship table or a character relationship diagram, etc. This information reflects the relationships between virtual characters and/or between virtual characters and NPC characters. Upon receiving a request for character relationship information from a terminal, the server can send the character relationship information to the terminal. The request for character relationship information can be sent by the terminal upon detecting a triggering operation by the user on a character relationship invocation control in the display interface of the first virtual scene.

In addition, the terminal can generate memory information corresponding to each virtual character. The memory information can be in the form of text, video, audio, image, etc., containing the personal stories of the corresponding virtual characters. Upon receiving a request for memory information from the terminal, the server can send the memory information of the virtual character corresponding to the terminal to the terminal. The request for memory information can be sent by the terminal upon detecting a triggering operation by the user on a memory invocation control in the display interface of the first virtual scene.

In step 1302, the server receives interaction information sent by the terminal.

The interaction information is sent by the terminal after the virtual character interacts with the virtual object under the user's control instruction for the virtual character.

In an optional embodiment of the present disclosure, the server can also receive virtual character interaction information sent by the terminal. The server can generate first multimedia data about the interaction between virtual characters based on the virtual character interaction information and send the first multimedia data to the terminals of various users, enabling the terminals of various users to display the interactions between the virtual characters based on the first multimedia data.

In another optional embodiment of the present disclosure, the server can also receive NPC interaction information sent by the terminals. The server can generate second multimedia data about the interactions between virtual characters and NPCs based on the NPC interaction information and send the second multimedia data to the terminals of various users, enabling terminals of various users to display the interactions between virtual characters and NPCs based on the second multimedia data.

In step 1303, the server obtains the search clue to be added to the clue pool based on the interaction information.

As described above, the clue pool can include both a shared clue pool and a private clue pool. In optional embodiments of the present disclosure, the interaction information described above may include a password input by the user. If the password is successfully verified, the server can obtain the search clue corresponding to the password to be added to the clue pool.

After obtaining the search clue to be added to the clue pool, the server can add the search clue to the clue pool. Subsequently, the server can feedback the clue pool to the terminal (e.g., in response to a request from the terminal), allowing the terminal to display the search clue using the clue pool as a carrier. The additions of the search clue to the shared clue pool and the private clue pool according to the embodiments of the present disclosure will be described below, respectively.

I. The server adds the search clue to the shared clue pool.

Optionally, taking the terminal corresponding to the first user (i.e., a first terminal) as an example, when the server receives a first add instruction from the first terminal for a first search clue, the server adds the first search clue to the shared clue pool, where the first add instruction is sent by the first terminal in response to a sharing instruction triggered by the first user.

In addition, after the current clue-searching stage, if the server detects a lack of a target search clue associated with a target virtual object in the shared clue pool, the server can add the target search clue to the shared clue pool, where the target virtual object has not interacted with the virtual character during historical clue-searching stages, and the importance level of the target virtual object is preset as important.

In optional embodiments of the present disclosure, the server can receive in advance a labeling instruction for a specific virtual object among the multiple virtual objects. The labeling instruction may be, for example, triggered by technical personnel. The server can then preset the specific virtual object as important according to the labeling instruction.

II. The server adds the search clue to the private clue pool.

Optionally, taking the terminal corresponding to the first user (i.e., the first terminal) as an example, when the server receives a second add instruction from the first terminal for the first search clue, the server adds this first search clue to the private clue pool of the first user. The second add instruction is sent by the first terminal in response to a privatization instruction triggered by the first user.

In optional embodiments of the present disclosure, upon receiving the second add instruction from the first terminal for the first search clue, the server may send an interaction status change instruction to all terminals except the first terminal. The interaction status change instruction indicates that the interaction status of the first virtual object associated with the first search clue is changed to not interactable with virtual characters. As such, it ensures the exclusivity of the first user to this first search clue. However, if exclusivity of the first user to this first search clue is not required, the server may not send the interaction status change instruction. In this case, after the first search clue is added to the private clue pool of the first user, other virtual characters can continue to interact with the first virtual object, and the server can also add the first search clue to the private clue pools of other users.

It should be noted that the server can receive in advance a clue property configuration instruction, which may be triggered by technical personnel. According to the clue property configuration instruction, the server can configure search clues as one of the following: 1. Not eligible for privatization and only for sharing; 2. Eligible for both privatization and sharing.

Referring to FIG. 14, on the basis of the embodiment described above, the present disclosure provides a method for displaying a second virtual scene different from the first virtual scene. As shown in FIG. 14, the process of displaying the second virtual scene includes the following steps 1401-1402.

In step 1401, the server generates a second virtual scene.

In optional embodiments of the present disclosure, each terminal can receive a scene switching instruction. Upon receiving the scene switching instruction, each terminal can send a request to the server. The server generates the second virtual scene in response to the request. Since the second virtual scene has been described above, it will not be repeated here.

In step 1402, the server sends the second virtual scene to each terminal for display.

Optionally, during the display of the second virtual scene on each terminal, the server can also receive search clue display requests from the terminals. The server can obtain the search clue corresponding to the display request and generate an image of the search clue. Subsequently, the server can send the image of the search clue to each terminal for display. Optionally, the search clue display requests can be sent by the terminals upon detecting a trigger instruction from the user for the search clue in the clue pool, where the clue pool can be a shared clue pool or a private clue pool. The search clue corresponding to the search clue display request is just the triggered search clue in the clue pool.

In optional embodiments of the present disclosure, upon receiving the search clue display request from the terminal, the server can also obtain an image of the virtual object associated with the search clue corresponding to the search clue display request and send the image of the virtual object to each terminal for display.

In a possible implementation of the present disclosure, the server can generate multiple images of the search clue and/or the virtual object associated with the search clue according to the fields of view of the various virtual characters, and send the generated images to the terminals for display in the second virtual scene. Consequently, different terminals can display the search clue and/or the virtual object according to the fields of view of the virtual characters controlled by corresponding users.

In optional embodiments of the present disclosure, taking the terminal corresponding to the first user (i.e., the first terminal) as an example, upon receiving a field of view change instruction for the first virtual character from the first terminal, the server can generate a new image of the search clue and/or virtual object according to the changed field of view of the first virtual character, and send the new image to the first terminal for display in the second virtual scene.

In another possible implementation of the present disclosure, the server can generate an image of the search clue and/or the virtual object associated with the search clue according to the field of view corresponding to a target location, and send the generated image to each terminal for display in the second virtual scene. The target location is outside of the various virtual characters, allowing different terminals to display the search clue and/or the virtual object according to the same field of view (i.e., the field of view corresponding to the target location).

In optional embodiments of the present disclosure, if the search clue to be displayed in the second virtual scene is of a multimedia type, the server may not generate the image corresponding to the search clue, or the server can generate an image of the description information corresponding to the search clue, as described above and send the image to each terminal for displaying the description information corresponding to the search clue.

Additionally, taking the terminal corresponding to the first user (i.e., the first terminal) as an example, if the search clue to be displayed in the second virtual scene is of a multimedia type, the server can, upon receiving a content obtaining instruction from the first terminal, obtain the search clue according to the content obtaining instruction and send it to each terminal for play. The content obtaining instruction is sent by the first terminal in response to a trigger instruction for a content play control displayed in the second virtual scene.

As described above, besides displaying search clues, the second virtual scene can also allow users to speak and discuss the solving of puzzles.

During the user speaking process, optionally, taking the terminal corresponding to the first user (i.e., the first terminal) as an example, the server can receive speech information sent by the first terminal, where the speech information carries the first user's first voice signal. The server sends the first voice signal to each terminal for play.

In an optional embodiment of the present disclosure, in the second virtual scene, each user can speak sequentially in order. In this case, when the server determines, according to a predetermined speaking order, that the current moment is the speaking moment of the first virtual character, the server can send a speaking instruction to the first terminal. The speaking instruction is used to instruct the first terminal to collect the first voice signal and send the speech information. In optional embodiments of the present disclosure, the speaking instruction can also instruct the first terminal to display a speaking prompt for the first virtual character in the second virtual scene, where the speaking prompt is used to prompt the first user to speak.

It should be understood that although the steps in the flowcharts of the various embodiments described above are displayed sequentially as indicated by arrows, these steps are not necessarily executed in the order indicated by the arrows. Unless otherwise specified, there is no strict order restriction on the execution of these steps, and they can be executed in a different order. Furthermore, at least some of the steps depicted in the flowcharts of the various embodiments described above may include multiple steps or stages, and these steps or stages may not necessarily be completed at the same time. Instead, they may be executed at different times, and the execution order of these steps or stages may also not necessarily be sequential, but may occur in a rotating or alternating manner with at least some of other steps and steps or stages in the other steps.

Based on the same inventive concept, embodiments of the present disclosure also provide an apparatus for obtaining a clue in a virtual scene for implementing the method for obtaining a clue in a virtual scene as described above. The solution provided by the apparatus for solving problems is similar to that described in the above method. Therefore, specifics in one or more embodiments of the apparatus for obtaining a clue in a virtual scene provided below can refer to those in the method for obtaining a clue in the virtual scene described above, and will not be repeated here.

In an embodiment, as shown in FIG. 15, an apparatus 1500 for obtaining a clue in a virtual scene is provided, which includes a display module 1501 and a control module 1502.

The display module 1501 is configured to display a first virtual scene, which includes multiple virtual characters and multiple virtual objects. The multiple virtual characters include a first virtual character corresponding to a first user and a second virtual character corresponding to a second user.

The control module 1502 is configured to, in response to a control instruction from the first user for the first virtual character, control the first virtual character to interact with the first virtual object to obtain a first search clue to be added to the clue pool.

In optional embodiments of the present disclosure, the control module 1502 is specifically configured to control the first virtual character to approach a predetermined range around the first virtual object and display an interaction control when the first virtual character enters the predetermined range around the first virtual object, and in response to a first trigger instruction from the first user for the interaction control, control the first virtual character to interact with the first virtual object in an interaction manner corresponding to the first virtual object.

In optional embodiments of the present disclosure, the control module 1502 is specifically configured to display a password input interface during the interaction between the first virtual character and the first virtual object and receive a password input through the password input interface, and if the password is successfully verified, obtain the first search clue.

In optional embodiments of the present disclosure, the clue pool includes a shared clue pool. The control module 1502 is further configured to, in response to a sharing instruction triggered by the first user, add the first search clue to the shared clue pool. The shared clue pool also includes a second search clue obtained through the interaction between the second virtual character and a second virtual object.

In optional embodiments of the present disclosure, the control module 1502 is specifically configured to display a sharing control around the first virtual object, and in response to a second trigger instruction from the first user for the sharing control, add the first search clue to the shared clue pool.

In optional embodiments of the present disclosure, the display module 1501 is further configured to, if the shared clue pool lacks a target search clue associated with the target virtual object, display the target search clue in the shared clue pool.

In optional embodiments of the present disclosure, the clue pool includes a private clue pool, and the control module 1502 is further configured to, in response to a privatization instruction from the first user for the first virtual object, add the first search clue to the private clue pool.

In optional embodiments of the present disclosure, the control module 1502 is specifically configured to display a privatization control around the first virtual object, and in response to a third trigger instruction from the first user for the privatization control, add the first search clue to the private clue pool.

In optional embodiments of the present disclosure, the display module 1501 is further configured to display a navigation interface for the first virtual scene, where the navigation interface includes location information of virtual spaces in the first virtual scene that are accessible to the virtual characters.

In optional embodiments of the present disclosure, the display module 1501 is further configured to display a second virtual scene including multiple virtual characters, and display, in the second virtual scene, the search clue obtained from the first virtual scene.

In optional embodiments of the present disclosure, the second virtual scene includes a virtual desktop. The multiple virtual characters are located around the virtual desktop, and a display area for the search clues is located above the virtual desktop.

In optional embodiments of the present disclosure, the display module 1501 is specifically configured to display the search clue according to the field of view of the first virtual character, or display the search clue according to the field of view corresponding to a target location outside of the various virtual characters.

In optional embodiments of the present disclosure, the display module 1501 is further configured to, in the case of displaying the search clue according to the field of view of the first virtual character, in response to a field of view change instruction from the first user for the first virtual character, display the search clue according to the changed field of view.

In optional embodiments of the present disclosure, the display module 1501 is specifically configured to, in response to a clue pool invocation operation by the first user, display the clue pool on the current interface, and in response to a trigger instruction from the first user for the search clue in the clue pool, display the triggered search clue.

In optional embodiments of the present disclosure, the display module 1501 is further configured to display the virtual object associated with the search clue in the second virtual scene.

In optional embodiments of the present disclosure, the display module 1501 is further configured to, if the search clue is of a multimedia type, display a content play control in the second virtual scene, and in response to a fourth trigger instruction from the first user for the content play control, play the search clue.

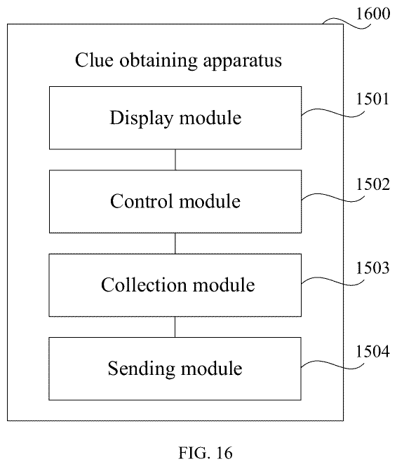

FIG. 16 illustrates another apparatus 1600 for obtaining a clue in a virtual scene provided by embodiments of the present disclosure. In addition to the modules included in the apparatus 1500 for obtaining a clue in a virtual scene, the apparatus 1600 for obtaining a clue in a virtual scene further includes a collection module 1503 and a sending module 1504.

The collection module 1503 is configured to collect a first voice signal from the first user.

The sending module 1504 is configured to send speech information to the server, where the speech information carries the first voice signal and is used to instruct the server to send the first voice signal to the terminals corresponding to the respective virtual characters for play.

In optional embodiments of the present disclosure, the collection module 1503 is specifically configured to, when it is determined that the current moment is the speaking moment of the first virtual character according to a predetermined speaking order, display a speaking prompt for the first virtual character in the second virtual scene, and collect the first voice signal, where the speaking prompt is used to prompt the first user to speak.

In optional embodiments of the present disclosure, the collection module 1503 is specifically configured to display a speech control in the second virtual scene, and in response to a fifth trigger instruction from the first user for the speech control, collect the first voice signal.

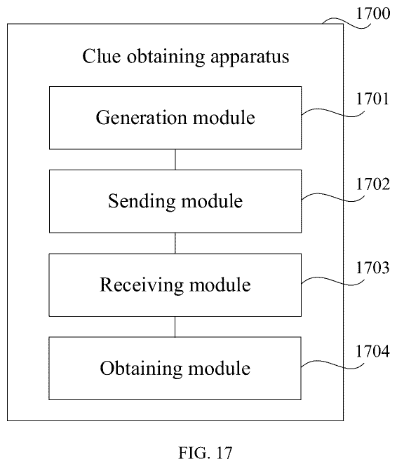

In an embodiment, as shown in FIG. 17, another apparatus 1700 for obtaining a clue in a virtual scene is provided, which includes a generation module 1701, a sending module 1702, a receiving module 1703, and an obtaining module 1704.

The generation module 1701 is configured to, in response to a scene trigger instruction from various users, generate the first virtual scene.

The sending module 1702 is configured to send the first virtual scene to the terminals of the various users for display. The first virtual scene includes multiple virtual objects and virtual characters corresponding to the respective users.

The receiving module 1703 is configured to receive interactive information sent by the terminal. The interaction information is sent by the terminal after the virtual character interacts with the virtual object under the user's control instruction for the virtual character.

The obtaining module 1704 is configured to obtain a search clue to be added to the clue pool based on the interactive information.

In optional embodiments of the present disclosure, the interactive information includes a password input by the user. The obtaining module 1704 is specifically configured to, if the password is successfully verified, obtain the search clue corresponding to the password to be added to the clue pool.

In optional embodiments of the present disclosure, the obtaining module 1704 is further configured to, when receiving a first add instruction sent by the first terminal for the first search clue, add the first search clue to the shared clue pool. The first add instruction is sent by the first terminal in response to a sharing instruction triggered by the first user. The shared clue pool includes a second search clue obtained through interaction between the second virtual character and the second virtual object.

In optional embodiments of the present disclosure, the obtaining module 1704 is further configured to: when receiving a second add instruction sent by the first terminal for the first search clue, add the first search clue to the private clue pool of the first user. The private clue pool includes the search clues obtained through interaction between the first virtual character corresponding to the first user and virtual objects. The second add instruction is sent by the first terminal in response to a privatization instruction triggered by the first user.

In optional embodiments of the present disclosure, the sending module 1702 is further configured to, when receiving the second add instruction, send an interaction status change instruction to all terminals except the first terminal, where the interaction status change instruction indicates that the interaction status of the first virtual object associated with the first search clue is changed to not interactable with virtual characters.

In optional embodiments of the present disclosure, the generation module 1701 is specifically configured to generate the first virtual scene based on the current clue-searching stage. Different clue-searching stages correspond to different virtual scenes.

In optional embodiments of the present disclosure, different clue-searching stages correspond to different virtual scenes, which includes at least one of the following: virtual spaces accessible to the virtual characters in virtual scenes corresponding to different clue-searching stages are different, and virtual objects available for the virtual characters to interact with in virtual scenes corresponding to different clue-searching stages are different.

In optional embodiments of the present disclosure, the generation module 1701 is further configured to, after entering the current clue-searching stage, generate a navigation interface for the first virtual scene, where the navigation interface includes location information of virtual spaces in the first virtual scene that are accessible to the virtual characters.

The sending module 1702 is further configured to send the navigation interface to each terminal for display.

In optional embodiments of the present disclosure, the obtaining module 1704 is further configured to, after the current clue-searching stage ends, when detecting a lack of a target search clue associated with a target virtual object in the shared clue pool, add the target search clue to the shared clue pool, where the target virtual object has not interacted with the virtual character in historical clue-searching stages, and the target virtual object is preset as important.

In optional embodiments of the present disclosure, the generation module 1701 is further configured to, in response to a scene switching instruction, generate the second virtual scene including multiple virtual characters.

The sending module 1702 is further configured to send the second virtual scene to each terminal for display.

The generation module 1701 is further configured to generate an image of the search clue during the display of the second virtual scene on each terminal.

The sending module 1702 is further configured to send the image of the search clue to each terminal for display in the second virtual scene.

In optional embodiments of the present disclosure, the second virtual scene includes a virtual desktop. The multiple virtual characters are located around the virtual desktop, and a display area for the search clues is located above the virtual desktop.

In optional embodiments of the present disclosure, the generation module 1701 is specifically configured to generate multiple images of the search clue according to the field of view of the first virtual character, or generate an image of the search clue according to the field of view corresponding to a target location outside of the various virtual characters.

In optional embodiments of the present disclosure, the generation module 1701 is further configured to, upon receiving a field of view change instruction for the first virtual character from the first terminal, generate a new image of the search clue according to the changed field of view of the first virtual character.

The sending module 1702 is further configured to send the new image to the first terminal for display in the second virtual scene.

In optional embodiments of the present disclosure, the obtaining module 1704 is further configured to, if the search clue is of a multimedia type, upon receiving a content obtaining instruction from the first terminal, obtaining the search clue according to the content obtaining instruction.

The sending module 1702 is further configured to send the search clue to each terminal for play, where the content obtaining instruction is sent by the first terminal in response to a trigger instruction for the content play control.

In optional embodiments of the present disclosure, the receiving module 1703 is further configured to receive speech information sent by the first terminal, where the speech information carries a first voice signal from the first user.

The sending module 1702 is further configured to send the first voice signal to each terminal for play.

In optional embodiments of the present disclosure, the sending module 1702 is further configured to, when the current moment is determined to be the speaking moment of the first virtual character according to a predetermined speaking order, send a speaking instruction to the first terminal. The speaking instruction is used to instruct the first terminal to collect the first voice signal and send the speech information.

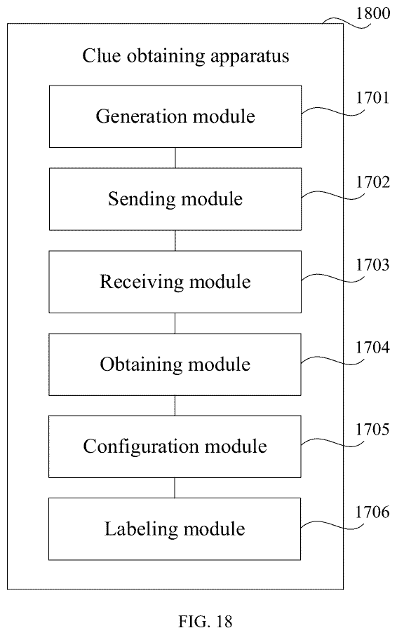

FIG. 18 illustrates another apparatus 1800 for obtaining a clue in a virtual scene provided by embodiments of the present disclosure. In addition to the various modules included in the apparatus 1700 for obtaining a clue in a virtual scene, the apparatus 1800 for obtaining a clue in a virtual scene further includes a configuration module 1705 and a labeling module 1706.

In optional embodiments of the present disclosure, the receiving module 1703 is further configured to receive a stage configuration instruction.

The configuration module 1705 is configured to configure different virtual spaces that are accessible to the virtual characters and/or different virtual objects available for the virtual characters to interact with for different clue-searching stages according to the stage configuration instruction.

In optional embodiments of the present disclosure, the receiving module 1703 is further configured to receive a labeling instruction for a specific virtual object among the multiple virtual objects.

The labeling module 1706 is configured to preset the specific virtual object as important according to the labeling instruction.

All the modules in the apparatus for obtaining a clue in a virtual scene described above can be fully or partially implemented through software, hardware, or their combinations. These modules can be in hardware form embedded in or independent of the processor in a computer device, or stored, in software form, in the memory of the computer device, facilitating the processor to call and execute the operations corresponding to these modules.

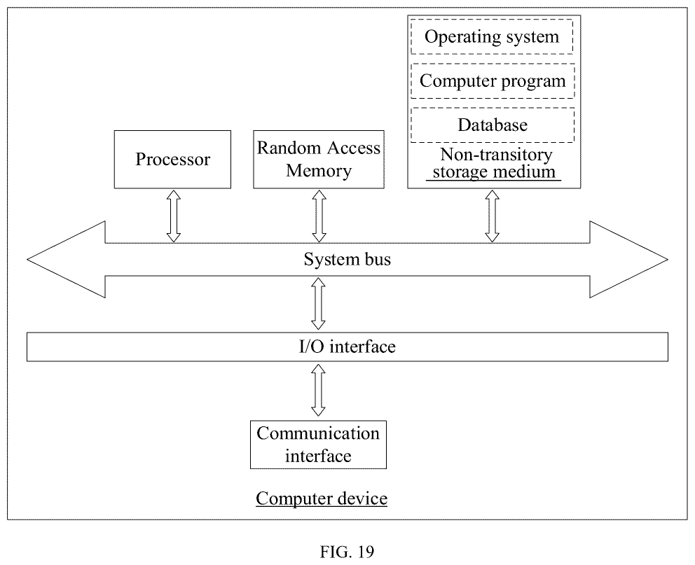

In an embodiment, a computer device is provided, which may be a server with an internal structure illustrated in FIG. 19. The computer device includes a processor, a memory, and a network interface connected via a system bus. The processor is configured to provide computing and control capabilities. The memory includes a non-transitory storage medium and a random access memory. The non-transitory storage medium stores an operating system, a computer program, and a database. The random access memory provides an environment for the operation of the operating system and computer program stored in the non-transitory storage medium. The network interface is configured for communication with external terminals via a network connection. The execution of the computer program by the processor implements the method for obtaining a clue in a virtual scene in various embodiments as described above.

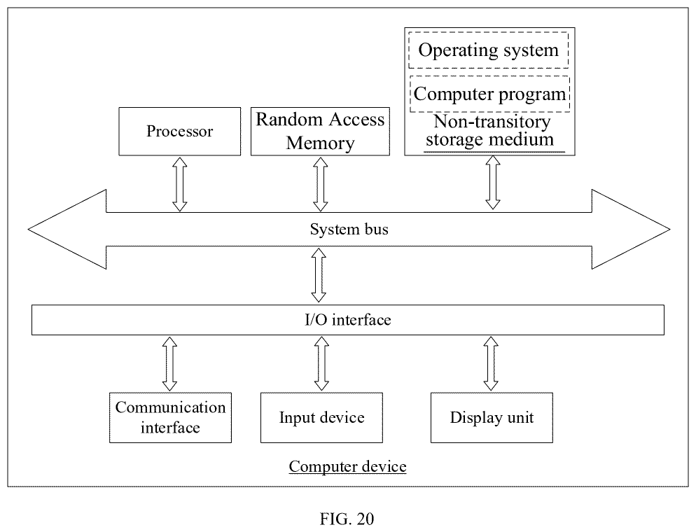

In an embodiment, a computer device is provided, which can be a terminal with an internal structure illustrated in FIG. 20. The computer device includes a processor, a memory, a communication interface, a display screen, and an input device connected via a system bus. The processor of the computer device is configured to provide computing and control capabilities. The memory of the computer device includes a non-transitory storage medium and a random access memory. The non-transitory storage medium stores an operating system and a computer program. The random access memory provides an environment for the operation of the operating system and the computer program stored in the non-transitory storage medium. The communication interface of the computer device is configured for wired or wireless communication with external terminals. Wireless communication can be achieved through WIFI, mobile cellular networks, NFC (Near Field Communication), or other technologies. The execution of the computer program by the processor implements the method for obtaining a clue in a virtual scene in various embodiments as described above. The display screen of the computer device may be a liquid crystal display screen or an electronic ink display screen. The input device of the computer device may be a touch layer overlaid on the display screen, buttons, a trackball, or a touchpad arranged on the housing of the computer device, or an external keyboard, touchpad, mouse, etc.

Those skilled in the art can understand that the structures illustrated in FIGS. 19 and 20 are merely block diagrams of portions of structures relevant to the present disclosure, and do not constitute limitations on the computer device to which the present disclosure is applied. The specific computer device may include more or fewer components than those shown in the figures, or may combine certain components, or may have different arrangements of components.

In an embodiment, a computer device is provided, including a memory and a processor. The memory stores a computer program, and the processor, when executing the computer program, performs the following steps: displaying a first virtual scene including multiple virtual characters and multiple virtual objects, the multiple virtual characters including a first virtual character corresponding to a first user and a second virtual character corresponding to a second user; and in response to a control instruction from the first user for the first virtual character, controlling the first virtual character to interact with the first virtual object to obtain a first search clue to be added to the clue pool.

In an embodiment, when executing the computer program, the processor further performs the following steps: controlling the first virtual character to approach a predetermined range around the first virtual object and displaying an interaction control when the first virtual character enters the predetermined range around the first virtual object; and in response to a first trigger instruction from the first user for the interaction control, controlling the first virtual character to interact with the first virtual object in an interaction manner corresponding to the first virtual object.

In an embodiment, when executing the computer program, the processor further performs the following steps: displaying a password input interface during the interaction between the first virtual character and the first virtual object and receiving a password input through the password input interface; and if the password is successfully verified, obtaining the first search clue.

In an embodiment, the clue pool includes a shared clue pool. When executing the computer program, the processor further performs the following step: in response to a sharing instruction triggered by the first user, adding the first search clue to the shared clue pool. The shared clue pool also includes a second search clue obtained through the interaction between the second virtual character and a second virtual object.

In an embodiment, when executing the computer program, the processor further performs the following steps: displaying a sharing control around the first virtual object; and in response to a second trigger instruction from the first user for the sharing control, adding the first search clue to the shared clue pool.

In an embodiment, when executing the computer program, the processor further performs the following steps: if the shared clue pool lacks a target search clue associated with the target virtual object, displaying the target search clue in the shared clue pool.

In an embodiment, the clue pool includes a private clue pool. When executing the computer program, the processor further performs the following step: in response to a privatization instruction from the first user for the first virtual object, adding the first search clue to the private clue pool.

In an embodiment, when executing the computer program, the processor further performs the following steps: displaying a privatization control around the first virtual object; and in response to a third trigger instruction from the first user for the privatization control, adding the first search clue to the private clue pool.

In an embodiment, when executing the computer program, the processor further performs the following step: displaying a navigation interface for the first virtual scene, where the navigation interface includes location information of virtual spaces in the first virtual scene that are accessible to the virtual characters.

In an embodiment, when executing the computer program, the processor further performs the following steps: displaying a second virtual scene including multiple virtual characters; and displaying, in the second virtual scene, the search clue obtained from the first virtual scene.

In an embodiment, the second virtual scene includes a virtual desktop. The multiple virtual characters are located around the virtual desktop, and a display area for the search clues is located above the virtual desktop.

In an embodiment, when executing the computer program, the processor further performs the following steps: displaying the search clue according to the field of view of the first virtual character, or displaying the search clue according to the field of view corresponding to a target location outside of the various virtual characters.

In an embodiment, when executing the computer program, the processor further performs the following step: in the case of displaying the search clue according to the field of view of the first virtual character, in response to a field of view change instruction from the first user for the first virtual character, displaying the search clue according to the changed field of view.

In an embodiment, when executing the computer program, the processor further performs the following steps: in response to a clue pool invocation operation by the first user, displaying the clue pool on the current interface; and in response to a trigger instruction from the first user for the search clue in the clue pool, displaying the triggered search clue.

In an embodiment, when executing the computer program, the processor further performs the following step: displaying the virtual object associated with the search clue in the second virtual scene.

In an embodiment, when executing the computer program, the processor further performs the following steps: if the search clue is of a multimedia type, displaying a content play control in the second virtual scene; and in response to a fourth trigger instruction from the first user for the content play control, playing the search clue.

In an embodiment, when executing the computer program, the processor further performs the following step: collecting a first voice signal from the first user and sending speech information to the server, where the speech information carries the first voice signal and is used to instruct the server to send the first voice signal to the terminals corresponding to the respective virtual characters for play.

In an embodiment, when executing the computer program, the processor further performs the following steps: when the current moment is determined to be the speaking moment of the first virtual character according to a predetermined speaking order, displaying a speaking prompt for the first virtual character in the second virtual scene, and collecting the first voice signal, where the speaking prompt is used to prompt the first user to speak.

In an embodiment, when executing the computer program, the processor further performs the following steps: displaying a speech control in the second virtual scene; and in response to a fifth trigger instruction from the first user for the speech control, collecting the first voice signal.

In an embodiment, a non-transitory computer-readable storage medium is provided. The non-transitory computer-readable storage medium stores a computer program which, when executed by a processor, implements the following steps: displaying a first virtual scene including multiple virtual characters and multiple virtual objects, the multiple virtual characters including a first virtual character corresponding to a first user and a second virtual character corresponding to a second user; and in response to a control instruction from the first user for the first virtual character, controlling the first virtual character to interact with the first virtual object to obtain a first search clue to be added to a clue pool.

In an embodiment, the computer program, when executed by the processor, further implements the following steps: controlling the first virtual character to approach a predetermined range around the first virtual object and displaying an interaction control when the first virtual character enters the predetermined range around the first virtual object; and in response to a first trigger instruction from the first user for the interaction control, controlling the first virtual character to interact with the first virtual object in an interaction manner corresponding to the first virtual object.

In an embodiment, the computer program, when executed by the processor, further implements the following steps: displaying a password input interface during the interaction between the first virtual character and the first virtual object and receiving a password input through the password input interface; and if the password is successfully verified, obtaining the first search clue.

In an embodiment, the clue pool includes a shared clue pool. The computer program, when executed by the processor, further implements the following steps: in response to a sharing instruction triggered by the first user, adding the first search clue to the shared clue pool. The shared clue pool also includes a second search clue obtained through the interaction between the second virtual character and a second virtual object.

In an embodiment, the computer program, when executed by the processor, further implements the following steps: displaying a sharing control around the first virtual object; and in response to a second trigger instruction from the first user for the sharing control, adding the first search clue to the shared clue pool.

In an embodiment, the computer program, when executed by the processor, further implements the following steps: if the shared clue pool lacks a target search clue associated with the target virtual object, displaying the target search clue in the shared clue pool.

In an embodiment, the clue pool includes a private clue pool. The computer program, when executed by the processor, further implements the following steps: in response to a privatization instruction from the first user for the first virtual object, adding the first search clue to the private clue pool.

In an embodiment, the computer program, when executed by the processor, further implements the following steps: displaying a privatization control around the first virtual object; and in response to a third trigger instruction from the first user for the privatization control, adding the first search clue to the private clue pool.

In an embodiment, the computer program, when executed by the processor, further implements the following step: displaying a navigation interface for the first virtual scene, where the navigation interface includes location information of virtual spaces within the first virtual scene that are accessible to the virtual characters.

In an embodiment, the computer program, when executed by the processor, further implements the following steps: displaying a second virtual scene including multiple virtual characters; and displaying, in the second virtual scene, the search clue obtained from the first virtual scene.

In an embodiment, the second virtual scene includes a virtual desktop. The multiple virtual characters are located around the virtual desktop, and a display area for the search clues is located above the virtual desktop.

In an embodiment, the computer program, when executed by the processor, further implements the following steps: displaying the search clue according to the field of view of the first virtual character, or displaying the search clue according to the field of view corresponding to a target location outside of the various virtual characters.

In an embodiment, the computer program, when executed by the processor, further implements the following steps: in the case of displaying the search clue according to the field of view of the first virtual character, in response to a field of view change instruction from the first user for the first virtual character, displaying the search clue according to the changed field of view.

In an embodiment, the computer program, when executed by the processor, further implements the following steps: in response to a clue pool invocation operation by the first user, displaying the clue pool on the current interface; and in response to a trigger instruction from the first user for the search clue in the clue pool, displaying the triggered search clue.

In an embodiment, the computer program, when executed by the processor, further implements the following steps: displaying the virtual object associated with the search clue in the second virtual scene.

In an embodiment, the computer program, when executed by the processor, further implements the following steps: if the search clue is of a multimedia type, displaying a content play control in the second virtual scene; and in response to a fourth trigger instruction from the first user for the content play control, playing the search clue.

In an embodiment, the computer program, when executed by the processor, further implements the following steps: collecting the first user's first voice signal and sending speech information to the server, where the speech information carries the first voice signal and is used to instruct the server to send the first voice signal to the terminals corresponding to the respective virtual characters for play.

In an embodiment, the computer program, when executed by the processor, further implements the following steps: when the current moment is determined to be the speaking moment of the first virtual character according to a predetermined speaking order, displaying a speaking prompt for the first virtual character in the second virtual scene, and collecting the first voice signal, where the speaking prompt is used to prompt the first user to speak.

In an embodiment, the computer program, when executed by the processor, further implements the following steps: displaying a speech control in the second virtual scene; and in response to a fifth trigger instruction from the first user for the speech control, collecting the first voice signal.

In an embodiment, a computer program product is provided, including a computer program which, when executed by a processor, implements the following steps: displaying a first virtual scene including multiple virtual characters and multiple virtual objects, the multiple virtual characters including a first virtual character corresponding to a first user and a second virtual character corresponding to a second user; and in response to a control instruction from the first user for the first virtual character, controlling the first virtual character to interact with the first virtual object to obtain a first search clue to be added to a clue pool.

In an embodiment, the computer program, when executed by the processor, further implements the following steps: controlling the first virtual character to approach a predetermined range around the first virtual object and displaying an interaction control when the first virtual character enters the predetermined range around the first virtual object; and in response to a first trigger instruction from the first user for the interaction control, controlling the first virtual character to interact with the first virtual object in an interaction manner corresponding to the first virtual object.

In an embodiment, the computer program, when executed by the processor, further implements the following steps: displaying a password input interface during the interaction between the first virtual character and the first virtual object and receiving a password input through the password input interface; and if the password is successfully verified, obtaining the first search clue.

In an embodiment, the clue pool includes a shared clue pool. The computer program, when executed by the processor, further implements the following steps: in response to a sharing instruction triggered by the first user, adding the first search clue to the shared clue pool. The shared clue pool also includes a second search clue obtained through the interaction between the second virtual character and a second virtual object.

In an embodiment, the computer program, when executed by the processor, further implements the following steps: displaying a sharing control around the first virtual object; and in response to a second trigger instruction from the first user for the sharing control, adding the first search clue to the shared clue pool.

In an embodiment, the computer program, when executed by the processor, further implements the following steps: if the shared clue pool lacks a target search clue associated with the target virtual object, displaying the target search clue in the shared clue pool, where the target virtual object has not interacted with the virtual character in historical clue-searching stages, and the target virtual object is preset as important.

In an embodiment, the clue pool includes a private clue pool. The computer program, when executed by the processor, further implements the following steps: in response to a privatization instruction from the first user for the first virtual object, adding the first search clue to the private clue pool.

In an embodiment, the computer program, when executed by the processor, further implements the following steps: displaying a privatization control around the first virtual object; and in response to a third trigger instruction from the first user for the privatization control, adding the first search clue to the private clue pool.

In an embodiment, the computer program, when executed by the processor, further implements the following step: displaying a navigation interface for the first virtual scene, where the navigation interface includes location information of virtual spaces within the first virtual scene that are accessible to the virtual characters.

In an embodiment, the computer program, when executed by the processor, further implements the following steps: displaying a second virtual scene including multiple virtual characters; and displaying, in the second virtual scene, the search clue obtained from the first virtual scene.

In an embodiment, the second virtual scene includes a virtual desktop. The multiple virtual characters are located around the virtual desktop, and a display area for the search clues is located above the virtual desktop.

In an embodiment, the computer program, when executed by the processor, further implements the following steps: displaying the search clue according to the field of view of the first virtual character, or displaying the search clue according to the field of view corresponding to a target location outside of the various virtual characters.

In an embodiment, the computer program, when executed by the processor, further implements the following steps: in the case of displaying the search clue according to the field of view of the first virtual character, in response to a field of view change instruction from the first user for the first virtual character, displaying the search clue according to the changed field of view.

In an embodiment, the computer program, when executed by the processor, further implements the following steps: in response to a clue pool invocation operation by the first user, displaying the clue pool on the current interface; and in response to a trigger instruction from the first user for the search clue in the clue pool, displaying the triggered search clue.

In an embodiment, the computer program, when executed by the processor, further implements the following steps: displaying the virtual object associated with the search clue in the second virtual scene.

In an embodiment, the computer program, when executed by the processor, further implements the following steps: if the search clue is of a multimedia type, displaying a content play control in the second virtual scene; and in response to a fourth trigger instruction from the first user for the content play control, playing the search clue.

In an embodiment, the computer program, when executed by the processor, further implements the following steps: collecting the first user's first voice signal and sending speech information to the server, where the speech information carries the first voice signal and is used to instruct the server to send the first voice signal to the terminals corresponding to the respective virtual characters for play.

In an embodiment, the computer program, when executed by the processor, further implements the following steps: when the current moment is determined to be the speaking moment of the first virtual character according to a predetermined speaking order, displaying a speaking prompt for the first virtual character in the second virtual scene, and collecting the first voice signal, where the speaking prompt is used to prompt the first user to speak.

In an embodiment, the computer program, when executed by the processor, further implements the following steps: displaying a speech control in the second virtual scene; and in response to a fifth trigger instruction from the first user for the speech control, collecting the first voice signal.

In an embodiment, a computer device is provided, including a memory and a processor. The memory stores a computer program, and the processor, when executing the computer program, performs the following steps: in response to a scene trigger instruction from various users, generating a first virtual scene; sending the first virtual scene to terminals of the various users for display, where the first virtual scene includes multiple virtual objects and virtual characters corresponding to the various users; receiving interactive information sent by the terminal, where the interaction information is sent by the terminal after the virtual character interacts with the virtual object under the user's control instruction for the virtual character; and obtaining a search clue to be added to the clue pool based on the interactive information.

In an embodiment, the interaction information includes a password input by the user. The processor, when executing the computer program, performs the following steps: if the password is successfully verified, obtaining the search clue corresponding to the password to be added to the clue pool.

In an embodiment, the processor, when executing the computer program, performs the following steps: when receiving a first add instruction sent by the first terminal for the first search clue, adding the first search clue to the shared clue pool. The first add instruction is sent by the first terminal in response to a sharing instruction triggered by the first user. The shared clue pool includes a second search clue obtained through interaction between the second virtual character and the second virtual object.

In an embodiment, the processor, when executing the computer program, performs the following steps: when receiving a second add instruction sent by the first terminal for the first search clue, adding the first search clue to the private clue pool. The private clue pool includes the search clues obtained through interaction between the first virtual character corresponding to the first user and virtual objects. The second add instruction is sent by the first terminal in response to a privatization instruction triggered by the first user.

In an embodiment, the processor, when executing the computer program, performs the following steps: when receiving the second add instruction, sending an interaction status change instruction to all terminals except the first terminal, where the interaction status change instruction indicates that the interaction status of the first virtual object associated with the first search clue is changed to not interactable with virtual characters.

In an embodiment, the processor, when executing the computer program, performs the following step: generating the first virtual scene based on the current clue-searching stage. Different clue-searching stages correspond to different virtual scenes.

In an embodiment, different clue-searching stages correspond to different virtual scenes, which includes at least one of the following:
virtual spaces accessible to virtual characters in virtual scenes corresponding to different clue-searching stages are different; and
virtual objects available for virtual characters to interact with in virtual scenes corresponding to different clue-searching stages are different.

In an embodiment, the processor, when executing the computer program, performs the following steps: receiving a stage configuration instruction; configuring different virtual spaces that are accessible to virtual characters and/or different virtual objects available for virtual characters to interact with for different clue-searching stages according to the stage configuration instruction.

In an embodiment, the processor, when executing the computer program, performs the following steps: generating a navigation interface for the first virtual scene, where the navigation interface includes location information of virtual spaces in the first virtual scene that are accessible to the virtual characters; and sending the navigation interface to each terminal for display.

In an embodiment, the processor, when executing the computer program, performs the following steps: when detecting a lack of a target search clue associated with a target virtual object in the shared clue pool, adding the target search clue to the shared clue pool, where the target virtual object has not interacted with the virtual character in historical clue-searching stages, and the target virtual object is preset as important.

In an embodiment, the processor, when executing the computer program, performs the following steps: receiving a labeling instruction for a specific virtual object among multiple virtual objects, and presetting the specific virtual object as important according to the labeling instruction.

In optional embodiments of the present disclosure, the processor, when executing the computer program, performs the following steps: in response to a scene switching instruction, generating a second virtual scene including multiple virtual characters; sending the second virtual scene to each terminal for display; generating multiple images of the search clue during the display of the second virtual scene on each terminal; and sending the multiple images of the search clue to each terminal for display in the second virtual scene.

In an embodiment, the second virtual scene includes a virtual desktop. The multiple virtual characters are located around the virtual desktop, and a display area for the search clues is located above the virtual desktop.

In an embodiment, the processor, when executing the computer program, performs the following steps: generating multiple images of the search clue according to the field of view of the first virtual character, or generating multiple images of the search clue according to the field of view corresponding to a target location outside of the various virtual characters.

In an embodiment, the processor, when executing the computer program, performs the following steps: upon receiving a field of view change instruction for the first virtual character from the first terminal, generating a new image of the search clue according to the changed field of view of the first virtual character, and sending the new image to the first terminal for display in the second virtual scene.

In an embodiment, the field of view change instruction controls rotation of the head of the first virtual character.

In an embodiment, the processor, when executing the computer program, performs the following steps: if the search clue is of a multimedia type, upon receiving a content obtaining instruction from the first terminal, obtaining the search clue according to the content obtaining instruction, and sending the search clue to each terminal for play, where the content obtaining instruction is sent by the first terminal in response to a trigger instruction for the content play control.

In an embodiment, the processor, when executing the computer program, performs the following steps: receiving speech information sent by the first terminal, where the speech information carries a first voice signal from the first user, and sending the first voice signal to each terminal for play.

In an embodiment, the processor, when executing the computer program, performs the following steps: when the current moment is determined to be the speaking moment of the first virtual character according to a predetermined speaking order, sending a speaking instruction to the first terminal, where the speaking instruction is used to instruct the first terminal to collect the first voice signal and send the speech information.

In an embodiment, a non-transitory computer-readable storage medium is provided. The non-transitory computer-readable storage medium stores a computer program which, when executed by a processor, implements the following steps: in response to a scene trigger instruction from various users, generating a first virtual scene; sending the first virtual scene to terminals of the various users for display, where the first virtual scene includes multiple virtual objects and virtual characters corresponding to the various users; receiving interactive information sent by the terminal, where the interaction information is sent by the terminal after the virtual character interacts with the virtual object under the user's control instruction for the virtual character; and obtaining a search clue to be added to the clue pool based on the interactive information.

In an embodiment, the interaction information includes a password input by the user. The computer program, when executed by the processor, further implements the following steps: if the password is successfully verified, obtaining the search clue corresponding to the password to be added to the clue pool.

In an embodiment, the computer program, when executed by the processor, further implements the following steps: when receiving a first add instruction sent by the first terminal for the first search clue, adding the first search clue to the shared clue pool. The first add instruction is sent by the first terminal in response to a sharing instruction triggered by the first user. The shared clue pool includes a second search clue obtained through interaction between the second virtual character and the second virtual object.

In an embodiment, the computer program, when executed by the processor, further implements the following steps: when receiving a second add instruction sent by the first terminal for the first search clue, adding the first search clue to the private clue pool. The private clue pool includes the search clues obtained through interaction between the first virtual character corresponding to the first user and virtual objects. The second add instruction is sent by the first terminal in response to a privatization instruction triggered by the first user.

In an embodiment, the computer program, when executed by the processor, further implements the following steps: when receiving the second add instruction, sending an interaction status change instruction to all terminals except the first terminal, where the interaction status change instruction indicates that the interaction status of the first virtual object associated with the first search clue is changed to not interactable with virtual characters.

In an embodiment, the computer program, when executed by the processor, further implements the following step: generating the first virtual scene based on the current clue-searching stage. Different clue-searching stages correspond to different virtual scenes.

In an embodiment, different clue-searching stages correspond to different virtual scenes, which includes at least one of the following: virtual spaces accessible to virtual characters in virtual scenes corresponding to different clue-searching stages are different; and virtual objects available for virtual characters to interact with in virtual scenes corresponding to different clue-searching stages are different.

In an embodiment, the computer program, when executed by the processor, further implements the following steps: receiving a stage configuration instruction; configuring different virtual spaces that are accessible to virtual characters and/or different virtual objects available for virtual characters to interact with for different clue-searching stages according to the stage configuration instruction.

In an embodiment, the computer program, when executed by the processor, further implements the following steps: after entering the current clue-searching stage, generating a navigation interface for the first virtual scene, where the navigation interface includes location information of virtual spaces in the first virtual scene that are accessible to the virtual characters; and sending the navigation interface to each terminal for display.

In an embodiment, the computer program, when executed by the processor, further implements the following steps: after the current clue-searching stage ends, when detecting a lack of a target search clue associated with a target virtual object in the shared clue pool, adding the target search clue to the shared clue pool, where the target virtual object has not interacted with the virtual character in historical clue-searching stages, and the target virtual object is preset as important.

In an embodiment, the computer program, when executed by the processor, further implements the following steps: receiving a labeling instruction for a specific virtual object among multiple virtual objects; and presetting the specific virtual object as important according to the labeling instruction.

In optional embodiments of the present disclosure, the computer program, when executed by the processor, further implements the following steps: in response to a scene switching instruction, generating a second virtual scene including multiple virtual characters; sending the second virtual scene to each terminal for display; generating multiple images of the search clue during the display of the second virtual scene on each terminal; and sending the multiple images of the search clue to each terminal for display in the second virtual scene.

In an embodiment, the second virtual scene includes a virtual desktop. The multiple virtual characters are located around the virtual desktop, and a display area for the search clues is located above the virtual desktop.

In an embodiment, the computer program, when executed by the processor, further implements the following steps: generating multiple images of the search clue according to the field of view of the first virtual character, or generating multiple images of the search clue according to the field of view corresponding to a target location outside of the various virtual characters.

In an embodiment, the computer program, when executed by the processor, further implements the following steps: upon receiving a field of view change instruction for the first virtual character from the first terminal, generating a new image of the search clue according to the changed field of view of the first virtual character, and sending the new image to the first terminal for display in the second virtual scene.

In an embodiment, the field of view change instruction controls rotation of the head of the first virtual character.

In an embodiment, the computer program, when executed by the processor, further implements the following steps: if the search clue is of a multimedia type, upon receiving a content obtaining instruction from the first terminal, obtaining the search clue according to the content obtaining instruction, and sending the search clue to each terminal for play, where the content obtaining instruction is sent by the first terminal in response to a trigger instruction for the content play control.

In an embodiment, the computer program, when executed by the processor, further implements the following steps: receiving speech information sent by the first terminal, where the speech information carries a first voice signal from the first user, and sending the first voice signal to each terminal for play.

In an embodiment, the computer program, when executed by the processor, further implements the following steps: when the current moment is determined to be the speaking moment of the first virtual character according to a predetermined speaking order, sending a speaking instruction to the first terminal, where the speaking instruction is used to instruct the first terminal to collect the first voice signal and send the speech information.

In an embodiment, a computer program product is provided, including a computer program which, when executed by a processor, implements the following steps: in response to a scene trigger instruction from various users, generating a first virtual scene; sending the first virtual scene to terminals of the various users for display, where the first virtual scene includes multiple virtual objects and virtual characters corresponding to the various users; receiving interactive information sent by the terminal, where the interaction information is sent by the terminal after the virtual character interacts with the virtual object under the user's control instruction for the virtual character; and obtaining a search clue to be added to the clue pool based on the interactive information.

In an embodiment, the interaction information includes a password input by the user. The computer program, when executed by the processor, further implements the following steps: if the password is successfully verified, obtaining the search clue corresponding to the password to be added to the clue pool.

In an embodiment, the computer program, when executed by the processor, further implements the following steps: when receiving a first add instruction sent by the first terminal for the first search clue, adding the first search clue to the shared clue pool. The first add instruction is sent by the first terminal in response to a sharing instruction triggered by the first user. The shared clue pool includes a second search clue obtained through interaction between the second virtual character and the second virtual object.

In an embodiment, the computer program, when executed by the processor, further implements the following steps: when receiving a second add instruction sent by the first terminal for the first search clue, adding the first search clue to the private clue pool. The private clue pool includes the search clues obtained through interaction between the first virtual character corresponding to the first user and virtual objects. The second add instruction is sent by the first terminal in response to a privatization instruction triggered by the first user.

In an embodiment, the computer program, when executed by the processor, further implements the following steps: when receiving the second add instruction, sending an interaction status change instruction to all terminals except the first terminal, where the interaction status change instruction indicates that the interaction status of the first virtual object associated with the first search clue is changed to not interactable with virtual characters.

In an embodiment, the computer program, when executed by the processor, further implements the following step: generating the first virtual scene based on the current clue-searching stage. Different clue-searching stages correspond to different virtual scenes.

In an embodiment, different clue-searching stages correspond to different virtual scenes, which includes at least one of the following: virtual spaces accessible to virtual characters in virtual scenes corresponding to different clue-searching stages are different; and virtual objects available for virtual characters to interact with in virtual scenes corresponding to different clue-searching stages are different.

In an embodiment, the computer program, when executed by the processor, further implements the following steps: receiving a stage configuration instruction; configuring different virtual spaces that are accessible to virtual characters and/or different virtual objects available for virtual characters to interact with for different clue-searching stages according to the stage configuration instruction.

In an embodiment, the computer program, when executed by the processor, further implements the following steps: after entering the current clue-searching stage, generating a navigation interface for the first virtual scene, where the navigation interface includes location information of virtual spaces in the first virtual scene that are accessible to virtual characters; and sending the navigation interface to each terminal for display.

In an embodiment, the computer program, when executed by the processor, further implements the following steps: after the current clue-searching stage ends, when detecting a lack of a target search clue associated with a target virtual object in the shared clue pool, adding the target search clue to the shared clue pool, where the target virtual object has not interacted with the virtual character in historical clue-searching stages, and the target virtual object is preset as important.

In an embodiment, the computer program, when executed by the processor, further implements the following steps: receiving a labeling instruction for a specific virtual object among multiple virtual objects; and presetting the specific virtual object as important according to the labeling instruction.

In optional embodiments of the present disclosure, the computer program, when executed by the processor, further implements the following steps: in response to a scene switching instruction, generating a second virtual scene including multiple virtual characters; sending the second virtual scene to each terminal for display; generating multiple images of the search clue during the display of the second virtual scene on each terminal; and sending the multiple images of the search clue to each terminal for display in the second virtual scene.

In an embodiment, the second virtual scene includes a virtual desktop. The multiple virtual characters are located around the virtual desktop, and a display area for the search clues is located above the virtual desktop.

In an embodiment, the computer program, when executed by the processor, further implements the following steps: generating multiple images of the search clue according to the field of view of the first virtual character, or generating multiple images of the search clue according to the field of view corresponding to a target location outside of the various virtual characters.

In an embodiment, the computer program, when executed by the processor, further implements the following steps: upon receiving a field of view change instruction for the first virtual character from the first terminal, generating a new image of the search clue according to the changed field of view of the first virtual character; and sending the new image to the first terminal for display in the second virtual scene.

In an embodiment, the field of view change instruction controls rotation of the head of the first virtual character.

In an embodiment, the computer program, when executed by the processor, further implements the following steps: if the search clue is of a multimedia type, upon receiving a content obtaining instruction from the first terminal, obtaining the search clue according to the content obtaining instruction, and sending the search clue to each terminal for play, where the content obtaining instruction is sent by the first terminal in response to a trigger instruction for the content play control.

In an embodiment, the computer program, when executed by the processor, further implements the following steps: receiving speech information sent by the first terminal, where the speech information carries a first voice signal from the first user, and sending the first voice signal to each terminal for play.

In an embodiment, the computer program, when executed by the processor, further implements the following steps: when the current moment is determined to be the speaking moment of the first virtual character according to a predetermined speaking order, sending a speaking instruction to the first terminal, where the speaking instruction is used to instruct the first terminal to collect the first voice signal and send the speech information.

It should be noted that the user information (including but not limited to user device information, user personal information, etc.) and data (including but not limited to data used for analysis, stored data, displayed data, etc.) involved in the present disclosure are all information and data that have been authorized by the user or duly authorized by all parties.

Those with ordinary skills in the art can understand that all or part of the method described in the above embodiments can be implemented by instructing relevant hardware by computer programs. The computer programs can be stored in a non-transitory computer-readable storage medium. When executed, the computer program may implement the methods in the embodiments described above. In the embodiments provided in the present disclosure, any reference to memory, database, or other media may include at least one of non-transitory and transitory memories. Non-transitory memory may include read-only memory (ROM), tape, floppy disk, flash memory, optical memory, high-density embedded non-transitory memory, resistive random access memory (ReRAM), magnetoresistive random access memory (MRAM), ferroelectric random access memory (FRAM), phase change memory (PCM), graphene memory, etc. Transitory memory may include random access memory (RAM) or external high-speed cache memory, etc. RAM can come in various forms, such as static random access memory (SRAM) or dynamic random access memory (DRAM), etc. The databases involved in the embodiments of the present disclosure may include at least one of relational databases and non-relational databases. Non-relational databases may include blockchain-based distributed databases, etc., but not limited thereto. The processors involved in the embodiments of the present disclosure may include general-purpose processors, central processors, graphics processors, digital signal processors, programmable logic devices, data processing logic devices based on quantum computing, etc., but not limited thereto.

The various technical features of the above embodiments can be combined arbitrarily. To keep the description concise, not all possible combinations of technical features in the embodiments are described. However, as long as these combinations of technical features do not contradict each other, they should be considered within the scope of the present specification.

The embodiments described above only represent several embodiments of the present disclosure, which are described in a relatively specific and detailed manner. However, this should not be understood as limiting the scope of the patent application. It should be noted that for those with ordinary skills in the art, modifications and improvements can be made without departing from the conception of the present disclosure, which are all within the protection scope of the present disclosure. Therefore, the protection scope of the present disclosure should be determined by the appended claims.

What is claimed is:

1. A method for obtaining a clue in a virtual scene, comprising:
displaying a first virtual scene comprising multiple virtual characters and multiple virtual objects, the multiple virtual characters comprising a first virtual character corresponding to a first user and a second virtual character corresponding to a second user; and
controlling the first virtual character to interact with a first virtual object in response to a control instruction from the first user for the first virtual character to obtain a first search clue to be added to a clue pool.

2. The method according to claim 1, wherein controlling the first virtual character to interact with the first virtual object comprises:
controlling the first virtual character to approach a predetermined range around the first virtual object, and displaying an interaction control when the first virtual character enters the predetermined range around the first virtual object; and
controlling, in response to a first trigger instruction from the first user for the interaction control, the first virtual character to interact with the first virtual object in an interaction manner corresponding to the first virtual object.

3. The method according to claim 1, wherein controlling the first virtual character to interact with the first virtual object to obtain the first search clue to be added to the clue pool comprises:
displaying a password input interface during interaction of the first virtual character with the first virtual object, and receiving a password input through the password input interface; and
obtaining the first search clue if the password is successfully verified.

4. The method according to claim 1, wherein the clue pool comprises a shared clue pool, the method further comprising:
adding the first search clue to the shared clue pool in response to a sharing instruction triggered by the first user,
wherein the shared clue pool also comprises a second search clue obtained through interaction between the second character and a second virtual object.

5. The method according to claim 4, wherein adding the first search clue to the shared clue pool in response to the sharing instruction triggered by the first user comprises:
displaying a sharing control around the first virtual object; and
adding the first search clue to the shared clue pool in response to a second trigger instruction from the first user for the sharing control.

6. The method according to claim 4, further comprising:
if the shared clue pool lacks a target search clue associated with a target virtual object, displaying the target search clue in the shared clue pool.

7. The method according to claim 1, wherein the clue pool comprises a private clue pool, the method further comprising:
adding the first search clue to the private clue pool in response to a privatization instruction from the first user for the first virtual object.

8. The method according to claim 7, wherein adding the first search clue to the private clue pool in response to the privatization instruction from the first user for the first virtual object comprises:
displaying a privatization control around the first virtual object; and
adding the first search clue to the private clue pool in response to a third trigger instruction from the first user for the private collection control.

9. The method according to claim 1, further comprising:
displaying a navigation interface for the first virtual scene, the navigation interface comprising location information of a virtual space in the first virtual scene that is accessible to the virtual characters.

10. The method according to claim 1, further comprising:
displaying a second virtual scene comprising multiple virtual characters; and
displaying, in the second virtual scene, the search clue obtained from the first virtual scene.

11. The method according to claim 10, wherein the second virtual scene comprises a virtual desktop, the multiple virtual characters being located around the virtual desktop, and a display area for the search clue being located above the virtual desktop.

12. The method according to claim 10, wherein displaying the search clue obtained from the first virtual scene comprises:
displaying the search clue according to a field of view of the first virtual character; or
displaying the search clue according to a field of view corresponding to a target location, the target location being located outside of the multiple virtual characters.

13. The method according to claim 12, further comprising:
in a case of displaying the search clue according to the field of view of the first virtual character, in response to a field of view change instruction from the first user for the first virtual character, displaying the search clue according to a changed field of view.

14. The method according to claim 10, wherein displaying the search clue obtained from the first virtual scene comprises:
displaying the clue pool on a current interface in response to a clue pool invocation operation by the first user; and
displaying, in response to a triggered instruction of the first user for the search clue in the clue pool, a triggered search clue.

15. The method according to claim 10, further comprising:
displaying the virtual object associated with the search clue in the second virtual scene.

16. The method according to claim 10, wherein displaying the search clue obtained from the first virtual scene comprises:
displaying a content play control in the second virtual scene if the search clue is of a multimedia type; and
playing the search clue in response to a fourth trigger instruction from the first user for the content play control.

17. The method according to claim 10, further comprising:
collecting a first voice signal from the first user and sending speech information to a server, the speech information carrying the first voice signal and instructing the server to send the first voice signal to terminals corresponding to the virtual characters for play.

18. The method according to claim 17, wherein collecting the first voice signal from the first user comprises:
when a current moment is determined to be a speaking moment of the first virtual character according to a predetermined speaking order, displaying a speaking prompt for the first virtual character in the second virtual scene and collecting the first voice signal, wherein the speaking prompt is used to prompt the first user to speak.

19. The method according to claim 17, wherein collecting the first voice signal from the first user comprises:
displaying a speaking control in the second virtual scene; and
collecting the first voice signal in response to a fifth trigger instruction from the first user for the speaking control.

20. A computer device comprising a memory and a processor, the memory storing a computer program, wherein the processor, when executing the computer program, performs steps of the method according to claim 1.

21. A non-transitory computer-readable storage medium storing a computer program, wherein the computer program, when executed by a processor, implements steps of the method according to claim 1.

22. A computer program product comprising a computer program, wherein the computer program, when executed by a processor, implements steps of the method according to claim 1.
